(19) United States
(12) Patent Application Publication
(10) Pub. No.: US 2017/0177509 A1
(43) Pub. Date: Jun. 22, 2017

(54) HOST CONTROLLER AND PROGRAM EXECUTED BY HOST CONTROLLER

(71) Applicant: Renesas Electronics Corporation, Tokyo (JP)

(72) Inventor: Minoru KAMBARA, Tokyo (JP)

(21) Appl. No.: 15/365,667

(22) Filed: Nov. 30, 2016

(30) Foreign Application Priority Data
Dec. 18, 2015 (JP) 2015-247298

(51) Int. Cl. G06F 13/10; G06F 13/42

(52) U.S. Cl. CPC G06F 13/102; G06F 13/4221

(57) ABSTRACT

In USB, a configuration that can realize a higher transfer rate has been desired.

A host controller has a function of communicating with one or more nodes through a bus connected to a host port . The one or more nodes include, at least, one of a terminal located at an end of the bus and a hub that connects a port on the upper-level side to one or more ports in a cascade manner. The host controller acquires information associated with the length of time required from the time a packet is transmitted from the host port followed by reception by a terminal of a transfer destination to the time a response transmitted in accordance with the packet received by the terminal is received by the host port. In addition, the host controller adjusts the number or intervals of packets assigned to one frame on the basis of the acquired information.

### CROSS-REFERENCE TO RELATED APPLICATIONS

The disclosure of Japanese Patent Application No. 2015-247298 filed on Dec. 18, 2015 including the specification, drawings and abstract is incorporated herein by reference in its entirety.

### BACKGROUND

The disclosure relates to a host controller having a function of communicating with one or more nodes through a bus connected to a host port and a program executed by the host controller.

For example, USB (Universal Serial Bus) has been widely spread as an interface for connecting a personal computer to peripheral devices. USB has a plurality of revisions. For example, “Universal Serial Bus Specification Revision 2.0” (Apr. 27, 2000, Compaq Computer Corporation, Hewlett-Packard Company, Intel Corporation, Lucent Technologies Inc, Microsoft Corporation, NEC Corporation, Koninklijke Philips Electronics N.V.) defines the standard of USB revision 2.0 (hereinafter, also described as “USB 2.0”).

USB is a kind of master-slave connection. In a certain connection configuration, provided are one host that manages data transfer between devices and functions associated with devices of transfer destinations. Namely, the host functions as a master, and each function functions as a slave. In order to realize the diversity of connection, a hub that branches a transfer route into one or more routes may exist in addition to these main units. For example, a plurality of functions can be connected to a single port by connecting the hub to the port. However, a delay in accordance with the number of existing hubs may occur between the host and the function due to the existence of the hubs.

### SUMMARY

In USB 2.0, bidirectional data transfer is realized using a half duplex system. Namely, employed is a system in which the directions (from the host to each function (downstream) and from each function to the host (upstream)) of data transfer are switched in accordance with a predetermined cycle. Further, data is transmitted on a frame basis transferred at each predetermined cycle in USB 2.0. In this case, transfer scheduling is carried out, and one or more packets are assigned to each frame so that packet transfer and a response from any one of the functions are completed on a frame basis.

Basically, a higher transfer rate is preferable in any communication standard. In USB 2.0, a configuration that can realize a higher transfer rate has been desired.

The other objects and novel features will become apparent from the description of the specification and the accompanying drawings.

A host controller according to an embodiment has a function of communicating with one or more nodes through a bus connected to a host port . The one or more nodes include, at least, one of a terminal located at an end of the bus and a hub that connects a port on the upper-level side to one or more ports in a cascade manner. The host controller acquires information associated with the length of time required from the time a packet is transmitted from the host port followed by reception by a terminal of a transfer destination to the time a response transmitted in accordance with the packet received by the terminal is received by the host port . In addition, the host controller adjusts the number or intervals of packets assigned to one frame on the basis of the acquired information.

According to an embodiment, it is possible to realize a host controller that can realize a higher transfer rate.

### BRIEF DESCRIPTION OF THE DRAWINGS

FIG. 1 is a diagram for showing an example of a USB communication system compliant with a related technique of embodiments;

FIGS. 2A and 2B show examples of time charts for explaining data transfer in the USB communication system shown in FIG. 1;

FIG. 3 is a schematic view for explaining transfer scheduling compliant with the related technique of the embodiments;

FIGS. 4A and 4B are schematic views each explaining a problem in the transfer scheduling compliant with the related technique of the embodiments and an example of solving means for the problem;

FIG. 5 is a schematic view for showing a system configuration of a USB communication system according to a first embodiment;

FIG. 6 is a schematic view for explaining a functional configuration of a USB host;

FIG. 7 is a flowchart for showing a processing procedure of acquiring the maximum number of connected stages of hubs in the USB communication system according to the first embodiment;

FIG. 8 is a schematic view for showing an example of driver information acquired by the processing procedure shown in FIG. 7 in which the maximum number of connected stages of the hubs is acquired;

FIG. 9 is a flowchart for showing a processing procedure of transfer scheduling in the USB communication system according to the first embodiment;

FIG. 10 is a schematic view for showing a system configuration of a USB communication system according to a second embodiment;

FIG. 11 is a diagram for showing an example of data stored in a connected stage number register of the USB communication system according to the second embodiment;

FIGS. 12A and 12B are schematic views each explaining transfer scheduling in the USB communication system according to the second embodiment;

FIG. 13 is a flowchart for showing a processing procedure of the transfer scheduling in the USB communication system according to the second embodiment;

FIG. 14 is a schematic view for showing a system configuration of a USB communication system according to a third embodiment;

FIGS. 15A-15D are schematic views each showing a processing procedure of address setting in the USB communication system according to the third embodiment;

FIGS. 16A-16D are schematic views each explaining an updating process of a connected stage number register and an active connected stage number register while being associated with the address setting shown in FIGS. 15A-15D;

FIG. 17 is a flowchart for showing a processing procedure of acquiring the number of connected stages of hubs in the USB communication system according to the third embodiment;

FIG. 18 is a schematic view for explaining a process of acquiring the maximum number of connected stages of hubs in a USB communication system according to a fourth embodiment;

FIG. 19 is a schematic view for showing a system configuration of a USB communication system according to a fifth embodiment;

FIG. 20 is a diagram for showing an example of data stored in a measured value storing register of the USB communication system according to the fifth embodiment;

FIG. 21 is a schematic view for explaining measurement of time required for data transfer in the USB communication system according to the fifth embodiment;

FIG. 22 is a flowchart for showing a measurement procedure of a response time in the USE communication system according to the fifth embodiment;

FIG. 23 is a schematic view for showing an example of an effect of an improvement in the transfer rate by the transfer scheduling according to the embodiments; and

FIG. 24 is a schematic view for showing a configuration example of a host controller according to the embodiments.

### DETAILED DESCRIPTION

Several embodiments will be described in detail with reference to the drawings. It should be noted that the same reference numerals are given to the same or corresponding parts in the drawings, and the explanation thereof will not be repeated.

### A. Related Technique

First, a data transfer process in USB 2.0 will be described before describing a USB communication system according to the embodiments. In a connection configuration compliant with USB 2.0 in the following description, a device that controls data transfer between the connected devices (namely, a device that functions as a kind of master) is referred to as a “host”. The host communicates with one or more nodes through a bus connected to a port (host port) of the host.

A device that exchanges data under the control of the host (namely, a device that functions as a kind of slave) is·referred to as a “function” by focusing on the function provided by the device. The device that is the function corresponds to a terminal located at the end of the bus. It should be noted that there is a case in which one device has a plurality of functions. In this case, each function is used as an independent transfer destination. Further, a device that branches a transfer route into one or more routes is referred to as a “hub”. Namely, the hub connects the port on the upper-level side to one or more ports in a cascade manner. It should be noted that the host also functions as a “route hub”. These names are compliant with the USB 2.0 standard. Regarding more detailed configurations, refer to the above-described “Universal Serial Bus Specification Revision 2.0” (Apr. 27, 2000, Compaq Computer Corporation, Hewlett-Packard Company, Intel Corporation, Lucent Technologies Inc, Microsoft Corporation, NEC Corporation, Koninklijke Philips Electronics N.V.).

As described above, one or more nodes with which the host (route node) communicates include, at least, one of the function and the hub.

It should be noted that a method of data transfer according to the embodiments will be described while using the configuration based on USB 2.0 as a premise for convenience of explanation. However, the method can be applied to other revisions of the USB standard or other communication systems.

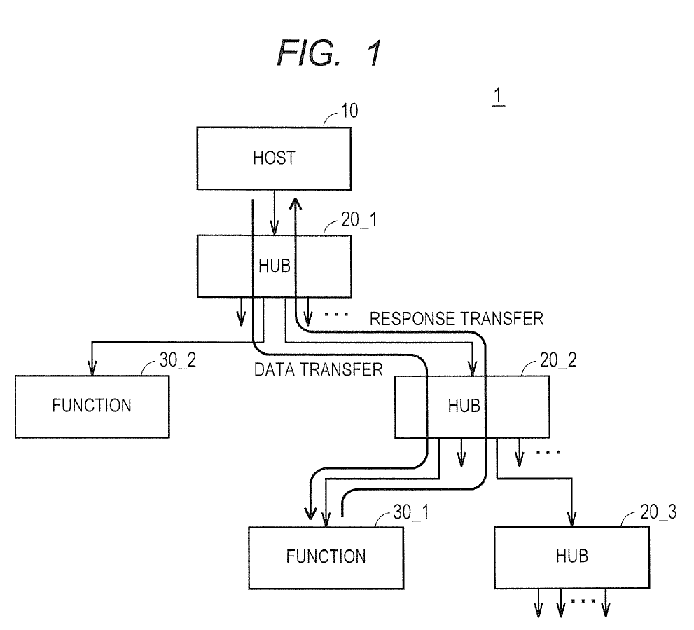

FIG. 1 is a diagram for showing an example of a USB communication system 1 compliant with the related technique of the embodiments. FIG. 1 shows a connection configuration example of the USB communication system 1 that includes a host 10, three hubs 20_1, 20_2, and 20_3, and two functions 30_1 and 30_2. More specifically, the hub 20_1 is connected on the downstream side of the host 10, and the function 30_2 and the hub 20_2 are connected on the downstream side of the hub 20_1. Further, the function 30_1 and the hub 20_3 are connected on the downstream side of the hub 20_2.

For example, in the data transfer from the host 10 to the function 30_1, a frame generated by the host is transferred through the hub 20_1 and the hub 20_2. On the contrary, in the data transfer from the function 30_1 to the host 10, a response generated by the function 30_1 is transferred through the hub 20_2 and the hub 20_1.

The data transfer in USB is managed on a frame basis transmitted at each predetermined cycle. One or more packets are assigned to each frame. The packet is a unit in transmission and reception. Typically, there are three kinds of packets: (1) a packet for control transfer, (2) a packet transmitted from the host 10 to the function 30, and (3) a packet transmitted from the function 30 to the host 10. Packets of different kinds are assigned to a single frame in some cases.

For convenience of explanation, packet transfer from the host 10 to the function 30 will be mainly described below. However, the present invention can be similarly applied to packet transfer from the function 30 to the host 10.

In the case where data is transferred from the host 10 to the function 30, the transfer of each packet is started from the host 10, and is completed when a response from the function 30 is received. On the contrary, in the case where data is transferred from the function 30 to the host 10, the function 30 transmits the data after receiving a packet for notifying transmission timing from the host 10, and the data transfer is completed when a response in accordance with the transmitted data is returned from the host 10 to the function 30.

In order to realize such data transfer, transfer scheduling is carried out. Specifically, one or more packets are assigned to each frame, so that the packet transfer and a response from any one of the transfer destinations are completed on a frame basis. In this case, the response time of a transfer destination is set in consideration of a case (worst case) in which the maximum number of hubs to be connected is 5 that is defined in the standard.

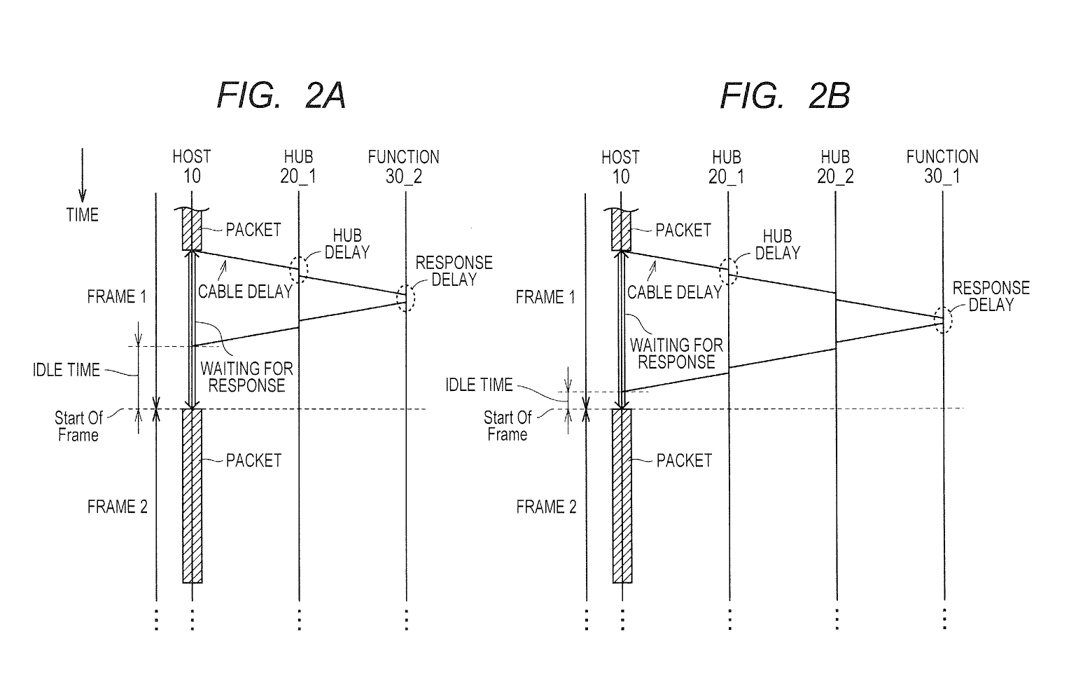

FIGS. 2A and 2B show examples of time charts for explaining data transfer in the USB communication system 1 shown in FIG. 1. FIG. 2A shows a transfer process between the host 10 and the function 30_2, and FIG. 2B shows a transfer process between the host 10 and the function 30_1. The time width of each element shown in FIGS. 2A-2B is not necessarily the same as the actual one, and the time width is illustrated by being appropriately changed for convenience of explanation.

With reference to FIG. 2A, one or more packets are assigned to one frame (frame 1) in accordance with a result of the transfer scheduling. In consideration of a period of time (delay) required from the time a packet in a frame is transmitted from the host 10 followed by reception by the function 30 of the transfer destination to the time some kind of response is transferred from the function of the transfer destination to the host, the subsequent packets and frames are scheduled.

The followings are typical delays that occur in the data transfer from the host to the function: (1) a Cable delay, (2) a hub delay, and (3) a response delay in the function. The cable delay means a period of time required for transmission of data through a cable that connects the host, the hubs, and the functions to each other, and includes, in addition to a period of time required for transmission of a signal through the cable, a period of time required for processes on the transmission side or the reception side of the signal. The hub delay includes a period of time required for a process of repeating received data to the downstream side or the upstream side. The response delay in the function includes a period of time required from the time the function receives data to the time the function generates and transmits a response in accordance with a result obtained by processing the received data.

In consideration of the delay shown in FIG. 2A, a period from the timing of completion of a packet assigned to any one of the frames (frame 1) to the assignment of the next packet is set as a period (response waiting period) of waiting for a response from the function. It should be noted that in the case where no response is received from the function during the response waiting period, the transfer of the packet is determined as a failure due to timeout. A re-transmission process of the packet is carried out if necessary.

As shown in FIG. 2B, although the transfer process between the-host 10 and the function 30_1 is the same, a period of time required from the time the host 10 transmits some kind of packet to the time the host 10 receives a response from the function 30_1 is longer than that in the case of FIG. 2A because two hubs (the hub 20_1 and the hub 20_2) are provided between the host 10 and the function 30_1.

Namely, the delay time until the response from the function is received is changed depending on the number of hubs (hereinafter, also referred to as “the number of connected stages” or “the number of stages”) provided in the transfer route between the host and the function of the transfer destination. Thus, it is necessary to carry out the transfer scheduling, so that the transmission of a packet and the reception of a response are completed in a single frame in any connection configuration.

In USB 2.0, the maximum number of connected stages of hubs is defined as “5”. Thus, the response time (worst case) of the function required for a case in which the number of stages of the hubs is 5 that is the maximum number in the standard is set as a premise in the scheduling of packets. Namely, on the assumption that the number of connected stages of the hubs is “5”, the assignment of packets to each frame is scheduled while defining a combination of the transmission of a packet and the reception of a response as a basic unit.

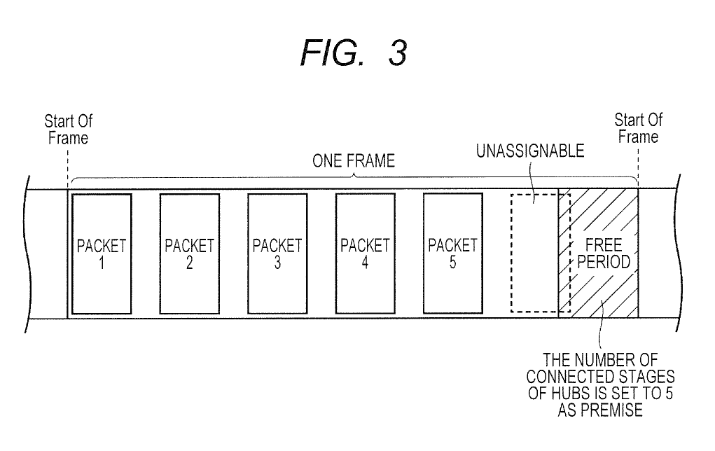

FIG. 3 is a schematic view for explaining the transfer scheduling compliant with the related technique of the embodiments. With reference to FIG. 3, the latter part of one frame includes a free period defined on the assumption that the number of connected stages of the hubs is “5”, and one or more packets are assigned to the frame so as not to be overlapped with the free period. The free period corresponds to a period of waiting for a response to the last packet from the function.

### B. Idea of new Problem and Method of Solving Problem

The inventors found the following new problems in the above-described communication system compliant with the USB standard. Namely, the transfer scheduling on a frame basis assumes the response time of the function in the case where hubs having the maximum number of stages in the standard are connected. However, in the case where the number of connected stages is small or no hubs are used, the actual response time of the function is shorter than the assumed response time. Therefore, there is a problem that an idle time that is not used for data transfer is generated.

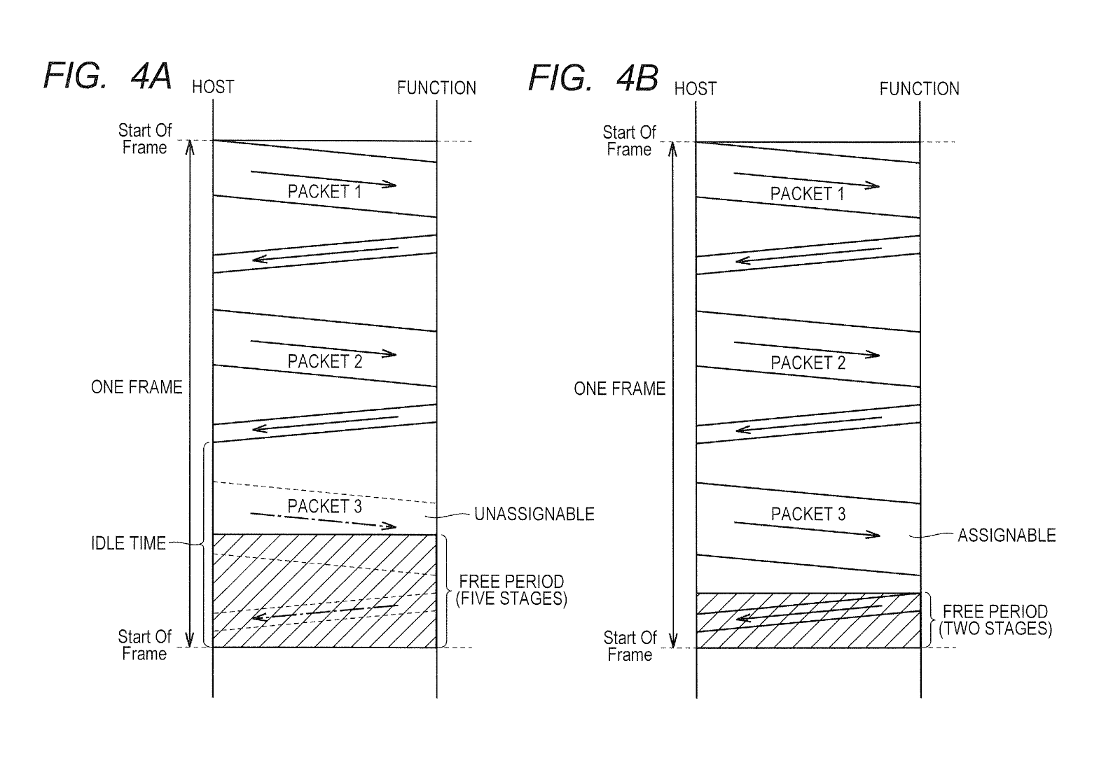

FIGS. 4A and 4B are schematic views each explaining a problem in the transfer scheduling compliant with the related technique of the embodiments and an example of solving means for the problem. With reference to FIG. 4A, the timing of assigning each packet is determined in one frame in consideration of the response time of the function. Namely, after the first packet is assigned, the timing (position) of assigning the second packet is determined in consideration of the response time of the function. As described above, the packets are sequentially assigned, and the last packet in the frame is set so as not to be overlapped with the response waiting period (illustrated as the “free period” in FIGS. 4A and 4B) that is preliminarily defined from the end of the frame. The free period is fixedly set to the length in accordance with the maximum number of connected stages (5 stages in the case of USB 2. 0) in the standard. Thus, an excessive response waiting period as compared to a response time that may occur is set in some cases. As a result, a period in which no packets are assigned corresponds to an idle time that does not contribute to the improvement of the transfer rate.

On the contrary, FIG. 4B illustrates an example of solving means for the above-described problems. In the transfer scheduling shown in FIG. 4B, the response waiting period (free period) is set in consideration of an actual connection configuration. In this case, a response from the function is also scheduled so as not to be included in the free period. For example, FIG. 4B shows an example in which the free period is set in the case where the number of connected stages is “2”. In the example of the transfer scheduling shown in FIG. 4B, it can be understood that one more packet is assigned to a single frame as compared to the example of the transfer scheduling shown in FIG. 4A.

As described above, the above-described problems are solved and the transfer rate is improved by carrying out the transfer scheduling in consideration of the actual connection configuration in the embodiments. More specifically, a host controller according to the embodiments has a function of acquiring information associated with the length of time required from the time a packet is transmitted from the port of the host 10 followed by reception by the function 30 that is a terminal of the transfer destination to the time a response transmitted in accordance with the packet received by the terminal is received by the port of the host 10. In addition, the number or intervals of packets assigned to one frame are adjusted on the basis of the information acquired by the function. The transfer rate can be improved by employing such a combination of functions.

It should be noted that FIGS. 4A and 4B show an example of changing the length of the free period set at the end of the frame for convenience of explanation. However, the present invention is not limited to this, but the transfer scheduling in consideration of the actual connection configuration can be carried out. For example, as will be described later, an interval between the preceding packet and the subsequent packet arranged in a frame may be adjusted in accordance with the actual connection configuration.

### C. First Embodiment

First, a USB communication system according to a first embodiment will be described. The USB communication system according to the first embodiment preliminarily acquires the maximum number of hubs (the maximum number of connected stages of hubs) existing on the routes from the host to the respective functions in a target connection configuration, and carries out the transfer scheduling on the basis of the response time in accordance with the acquired maximum number of connected stages.

### (c1: System Configuration)

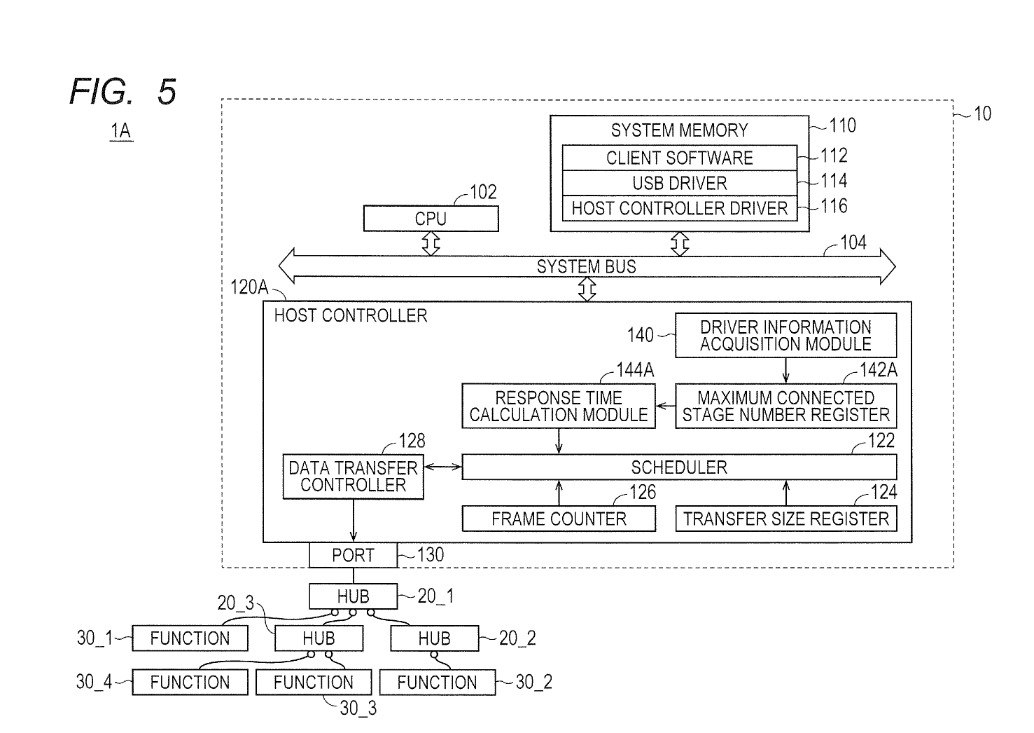

FIG. 5 is a schematic view for showing a system configuration of a USB communication system 1A according to the first embodiment. With reference to FIG. 5, the USB communication system 1A includes a host 10, one or more hubs 20_1, 20_2, 20_3, and the like (hereinafter, also collectively referred to as a “hub 20” in some cases), and one or more functions 30_1, 30_2, 30_3, and the like (hereinafter, also collectively referred to as a “function 30”).

The host 10 is typically mounted as a personal computer, a general-purpose microcomputer, or a dedicated device for specific use. As a functional configuration according to data transfer in USB, the host 10 includes a CPU (Central Processing Unit) 102 that is an example of a processor, a system memory 110, and a host controller 120A. These components are configured to be able to communicate with each other through a system bus 104. It should be noted that a plurality of host controllers 120A is connected to the system bus 104 in some cases.

The host controller 120A includes a scheduler 122, a transfer size register 124, a frame counter 126, a data transfer controller 128, a driver information acquisition module 140, a maximum connected stage number register 142A, and a response time calculation module 144A.

The scheduler 122 assigns one or more packets to each of frames having a predetermined cycle. More specifically, the scheduler 122 carries out the transfer scheduling on the basis of the size of data to be transferred that is stored in the transfer size register 124, a frame number stored in the frame counter 126, and a response time calculated by the response time calculation module 144A. The scheduler 122 sequentially updates the frame number and the like stored in the frame counter 126 in accordance with the implementation of the transfer scheduling.

When a data transfer command from the CPU 102 is given to the host controller 120A, the size of data to be transferred is written into the transfer size register 124.

The data transfer controller 128 performs bidirectional communications by switching the data transfer direction of the USB bus in time in accordance with the assignment of packets by the scheduler 122. More specifically, the data transfer controller 128 sequentially generates frames to each of which one or more packets are assigned in accordance with a transfer scheduling result by the scheduler 122, and transmits the generated frames from a port 130. It should be noted that the port 130 functions as a route hub.

In the case where a response to any one of the packets included in the transmitted frame cannot be received from the function 30 within the response waiting period (in the case of timeout), the data transfer controller 128 determines that the data transfer of the packet failed, and outputs information identifying the packet that failed in the data transfer. The scheduler 122 carries out scheduling for re-transmitting the packet that failed in the data transfer.

The driver information acquisition module 140 acquires information associated with the length of time required from the time a packet is transmitted from the port 130 of the host 10 followed by reception by the function 30 that is a terminal of the transfer destination to the time a response transmitted in accordance with the packet received by the terminal is received by the port 130 of the host 10. More specifically, the driver information acquisition module 140 acquires, as will be described later, driver information, and acquires the maximum number of connected stages of the hubs 20 existing on the routes to the respective functions 30 connected to the port 130.

The driver information acquisition module 140 stores the maximum number of connected stages into the maximum connected stage number register 142A. On the basis of the maximum number of connected stages stored in the maximum connected stage number register 142A, the response time calculation module 144A calculates the maximum value of a period of time (response time) from the time a packet is transmitted to the time a response from the function of the transfer destination is transferred to the host 10.

As described above, the host controller 120A according to the first embodiment calculates the response time of the function in accordance with the maximum number of connected stages of the hubs 20, and carries out the transfer scheduling for the frame in accordance with the calculated response time of the function.

The system memory 110 stores therein client software 112, a USB driver 114, and a host controller driver 116. Here, the functions of these components will be described.

### (c2: Hierarchized Structure of Software/Hardware)

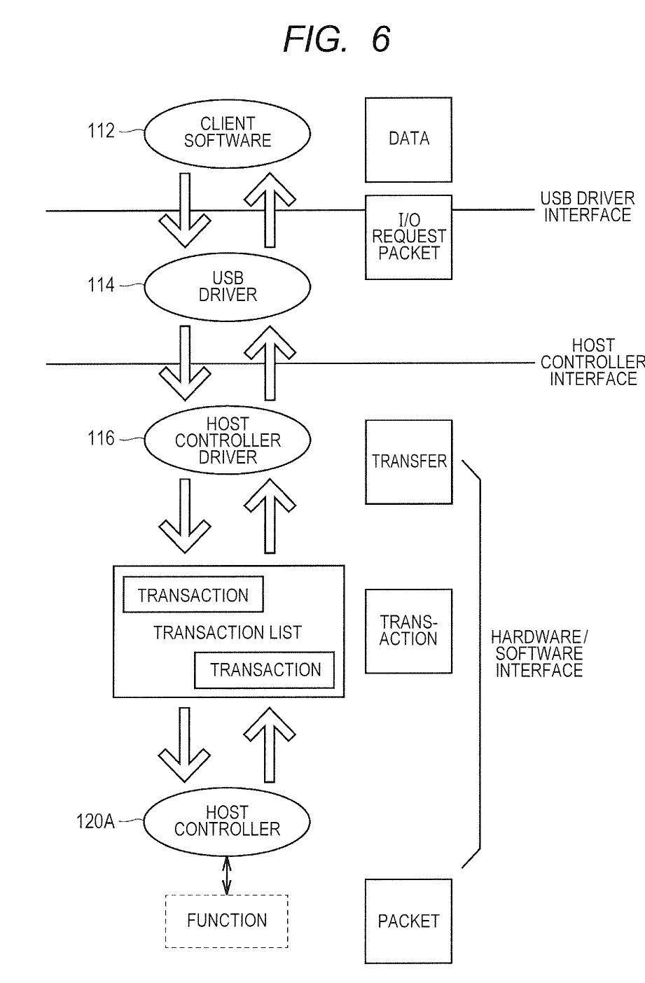

FIG. 6 is a schematic view for explaining a functional configuration of the USB host. With reference to FIG. 6, processes are shared among the hierarchized components to realize the data transfer in USB.

The client software 112 is application software using communications with one or more functions (nodes), and entirely controls exchanges of data between the host 10 and the function 30. The client software 112 gives one or more I/O request packets (IRPs) to the USB driver 114 to transfer some kind of data to a specific function 30. The I/O request packet is obtained by packaging target data, and includes information of a transfer destination.

The USB driver 114 is driver software for controlling the host controller 120A. The USB driver 114 outputs the I/O request packet to the host controller driver 116, and receives a packet from the function 30 to be output to the client software 112.

The host controller driver 116 carries out a transfer process to manage transmission and reception of packets. The host controller driver 120A exchanges with the hub 20 or the function 30 a signal obtained by encoding packets. The host controller driver 116 and the host controller driver 120A manage transactions (exchanges of data) on a packet basis on the basis of a transaction list. A response from any one of the functions 30 and a packet received from any one of the functions 30 is output to the client software 112 by following the reverse route.

There is a USB driver interface between the client software 112 and the USB driver 114, and there is a host controller interface between the USB driver 114 and the host controller driver 116.

The host controller 120A is connected to the CPU 102 that is a main operation unit executing the client software 112 and the USB driver 114. The host controller driver 116 and the host controller 120A realize actual data transfer, and there is a hardware/software interface between the both. More specifically, the host controller driver 116 replaces a command from the client software 112 into a command that can be understood by the host controller 120A.

### (c3: Acquisition of the Maximum Number of Connected Stages of Hubs)

Next, a method of acquiring the maximum number of connected stages for the function connected to the host 10 will be described.

In the communication system lA according to the first embodiment, the driver information acquisition module 140 refers to the driver information held by the USB driver 114 that is driver software, and acquires information associated with the length of time from the time a packet is transmitted from the port 130 of the host 10 to the time a response from the function 30 that is a terminal of the transfer destination is received. Namely, the driver information acquisition module 140 acquires the number of hubs 20 existing on the route from the port 130 of the host 10 to each function on the basis of the driver information.

In this case, the maximum number of hubs 20 existing on the route from the port 130 of the host 10 to each function connected to the port 130 of the host 10 is acquired. Namely, the routes from the host 10 to the respective functions 30 are tracked by referring to the driver information held by the USB driver 114, and the maximum number (the maximum value of the stages) of hubs 20 existing on the routes up to the respective functions 30 is determined.

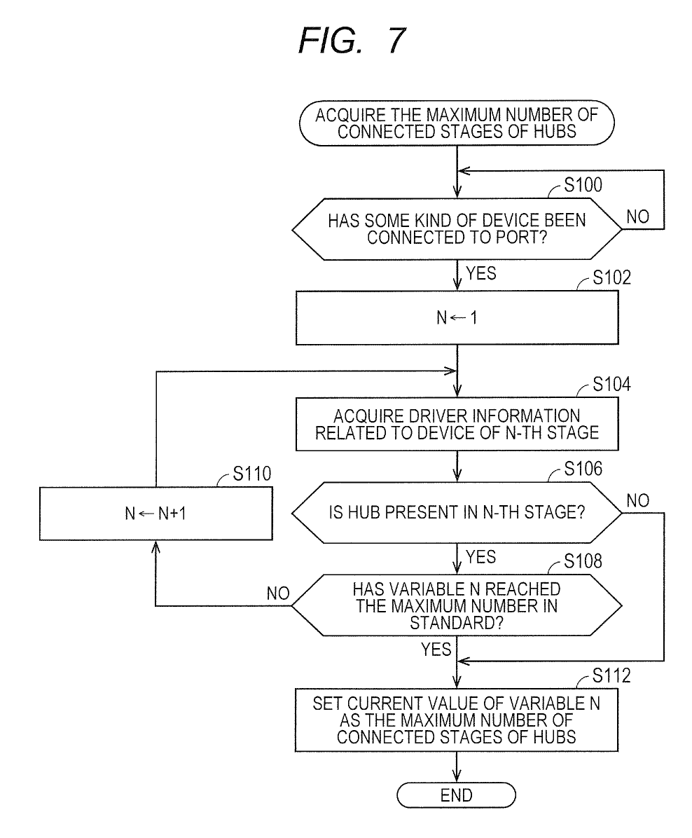

FIG. 7 is a flowchart for showing a processing procedure of acquiring the maximum number of connected stages of the hubs 20 in the USB communication system lA according to the first embodiment. Each step shown in FIG. 7 is basically executed by the driver information acquisition module 140 (FIG. 5) of the host controller 120A.

With reference to FIG. 7, the host controller 120A determines whether or not some sort of device (the hub 20 or the function 30) has been connected to the port 130 (Step S100). Specifically, when some sort of device is connected to the port 130 of the host 10 or the port of the hub 20, an interruption signal is generated. The host controller 120A determines the presence or absence of the connection of the device to the port 130 depending on the presence or absence of the generation of the interruption signal. If no device has been connected to the port 130 (in the case of NO in Step S100), the process of Step S100 is repeated.

On the contrary, if some sort of device has been connected to the port 130 (in the case of YES in Step S100), the host controller 120A sets a variable N representing the number of stages to “1” (Step S102), and acquires the driver information related to the devices of the N-th stage (Step S104). Namely, when Step S104 is executed first, information of the devices of the first stage connected to the port 130 of the host 10 is acquired.

Next, the host controller 120A determines whether or not the hub 20 is present in the N-th stage on the basis of the acquired driver information related to the devices of the N-th stage (Step S106). If the hub 20 is present in the N-th stage (in the case of YES in Step S106), the host controller 120A determines whether or not the variable N has reached the maximum number (“5” in the case of USB 2.0) of the standard (Step S108). If the variable N has not reached the maximum number of the standard (in the case of NO in Step S108), the host controller 120A increments the variable N by only one (Step S110), and repeats the processes after Step S104.

Namely, in the case where the hub 20 is included as the device of the first stage, the host controller 120A acquires the driver information of all the devices (namely, the devices of the second stage) connected to the hub 20. As similar to the above, in the case where the hub 20 is included as the device of the second stage, the host controller 120A acquires the driver information of all the devices (namely, the devices of the third stage) connected to the hub 20. As similar to the above, in the case where the hub 20 is included as the device of the third stage, the host controller 120A acquires the driver information of all the devices (namely, the devices of the fourth stage) connected to the hub 20. As similar to the above, in the case where the hub 20 is included as the device of the fourth stage, the host controller 120A acquires the driver information of all the devices (namely, the devices of the fifth stage) connected to the hub 20.

If no hub 20 is present in the N-th stage (in the case of NO in Step S106) or if the variable N has reached the maximum number of the standard (in the case of YES in Step S108), the host controller 120A sets the current value of the variable N as the maximum number of connected stages of the hubs 20 (Step S112). The set maximum number of connected stages is stored in the maximum connected stage number register 142A. Then, the acquisition process of the maximum number of connected stages of the hubs 20 is completed.

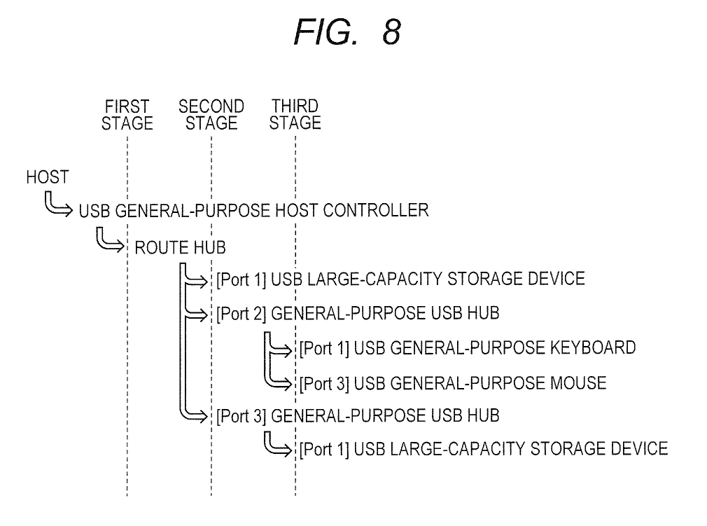

FIG. 8 is a schematic view for showing an example of the driver information acquired by the processing procedure shown in FIG. 7 in which the maximum number of connected stages of the hubs 20 is acquired. As shown in FIG. 8, the connection relations are sequentially acquired starting from the device located on the upstream side by the processing procedure shown in FIG. 7 in which the maximum number of connected stages of the hubs 20 is acquired. Then, the device located at the end on the downstream side, namely, the device having the maximum number of connected stages among those connected and the number of connected stages at the time are acquired.

It should be noted that in the configuration in which the driver information as shown in FIG. 8 can be acquired at a time, the maximum number of connected stages may be determined in such a manner that the driver information is acquired at a time in accordance with a processing procedure that is different from that shown in FIG. 7, and the acquired driver information is analyzed.

### (c4: Transfer Scheduling)

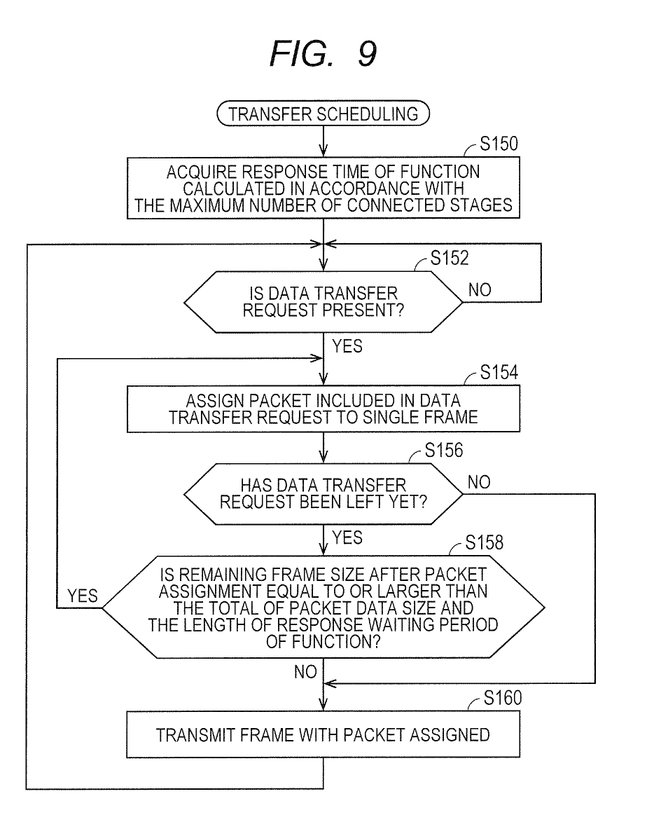

Next, the transfer scheduling in the host 10 will be described. FIG. 9 is a flowchart for showing a processing procedure of the transfer scheduling in the USB communication system lA according to the first embodiment. Each step shown in FIG. 9 is basically executed by the scheduler 122 (FIG. 5) of the host controller 120A.

With reference to FIG. 9, the host controller 120A acquires the response time of the function calculated in accordance with the maximum number of connected stages as a part of an initialization process (Step S150). The response time of the function is calculated by the response time calculation module 144A (FIG. 5) on the basis of the maximum number of connected stages stored in the maximum connected stage number register 142A.

Next, the host controller 120A determines whether or not a data transfer request (I/O request packet) from the client software 112 is present (Step S152). If no data transfer request is present (in the case of NO in Step S152), the process of Step S152 is repeated.

If the data transfer request is present (in the case of YES in Step S152), the host controller 120A assigns packets included in the data transfer request to a single frame (Step S154). Namely, the host controller 120A assigns one or more packets to each of the frames having a predetermined cycle. Then, after the assignment of the packets, the host controller 120A determines whether or not the data transfer request (I/O request packet) has been left yet (Step S156). If the data transfer request (I/O request packet) has been left yet (in the case of YES in Step S156), the host controller 120A determines whether or not the remaining frame size (remaining time) after the assignment of the packets is equal to or larger than the total of the packet data size (the length of the transmission period) and the length of the response waiting period of the function (Step S158). If the remaining frame size after the assignment of the packets is equal to or larger than the total of the packet data size and the length of the response waiting period of the function (in the case of YES in Step S158), the host controller 120A repeats the processes after Step S154.

If no data transfer request (I/O request packet) has been left (in the case of NO in Step S156) or if the remaining frame size after the assignment of the packets is smaller than the total of the packet data size and the length of the response waiting period of the function (in the case of NO in Step S158), the frame with one or more packets assigned is transmitted (Step S160). Then, the processes after Step S152 are repeated.

As described above, the scheduler 122 of the host controller 120A adjusts the number or intervals of packets assigned to one frame on the basis of the driver information acquired by the driver information acquisition module 140.

### (c5: Advantage)

The host controller 120A according to the first embodiment can easily acquire the number of connected stages of the hubs for each function by referring to the driver information held by the USB driver 114. The response waiting time after transmission of a packet can be optimized by acquiring such information in accordance with the delay time of the data transfer that may occur in the actual connection configuration. Namely, the response waiting time is not uniformly set in accordance with the maximum number of connected stages in the standard as described in the related technique, but the response waiting time can be shortened in accordance with the actual connection configuration (namely, the maximum value of connected stages). Accordingly, the number of packets assigned to a frame can be increased, and as a result, the transfer rate can be improved.

### D. Second Embodiment

In the above-described first embodiment, described is a processing example in which the maximum number of connected stages of the hubs 20 in the actual connection configuration is acquired by referring to the driver information managed by the USB driver 114, and the response time of the function is uniformly set on the basis of the acquired maximum number of connected stages of the hubs 20. On the contrary, the response time may be individually set instead of the number of connected stages for the function as the transfer destination.

Hereinafter, as a second embodiment, a configuration of realizing the transfer scheduling by setting the response time for each function will be described.

### (d1: System Configuration)

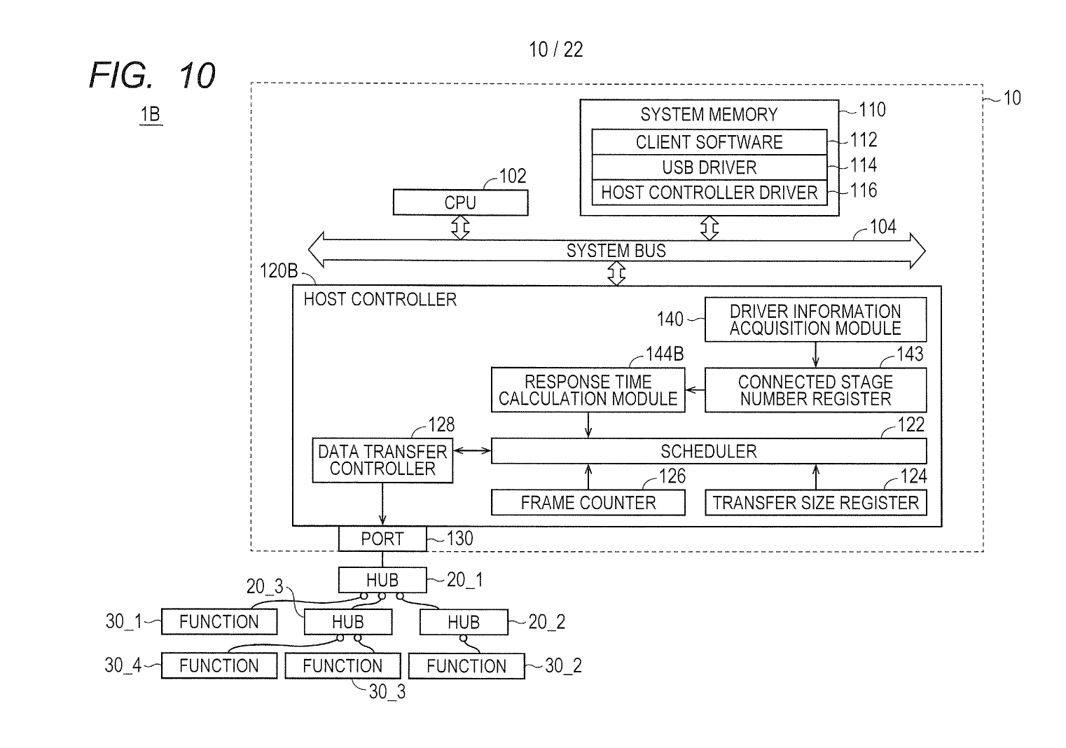

FIG. 10 is a schematic view for showing a system configuration of a USB communication system 1B according to the second embodiment. With reference to FIG. 10, the USB communication system 1B employs a host controller 120B instead of the host controller 120A as compared to the USB communication system 1A according to the first embodiment shown in FIG. 5. The host controller 120B employs a connected stage number register 143 and a response time calculation module 144B instead of the maximum connected stage number register 142A and the response time calculation module 144A as compared to the host controller 120A shown in FIG. 5.

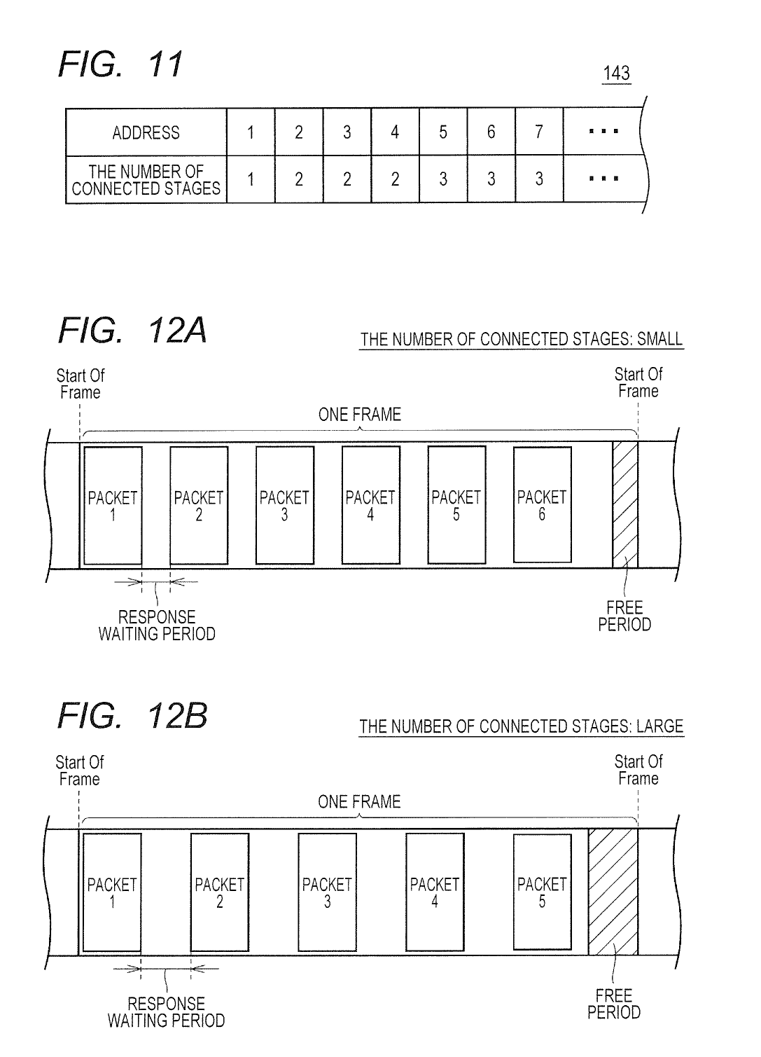

The connected stage number register 143 stores therein the number of connected stages for each of the devices (the hub 20 and the function 30). FIG. 11 is a diagram for showing an example of data stored in the connected stage number register 143 of the USB communication system 1B according to the second embodiment. With reference to FIG. 11, for example, the number of connected stages of each device is stored on an address basis.

The driver information acquisition module 140 acquires the number of hubs 20 existing on the route from the port 130 of the host 10 to each function 30 that is a terminal connected to the port 130 of the host 10. More specifically, the driver information acquisition module 140 acquires the driver information held by the USB driver 114 in accordance with the above-described procedure, and acquires the number of connected stages of each device on the basis of the acquired driver information. Then, the driver information acquisition module 140 stores the acquired number of connected stages of each device into the connected stage number register 143.

On the basis of the number of connected stages for each device stored in the connected stage number register 143, the response time calculation module 144B calculates a period of time (response time) from the time a packet is transmitted to each transfer destination to the time a response from the function of the transfer destination is transferred to the host 10. It should be noted that the response time calculation module 144B may calculate the response time for each function of the transfer destination, or may calculate the response time for each number of connected stages on the assumption that the response time is the same among the functions having the same number of connected stages.

The transfer scheduling in the scheduler 122 will be described later. The other components have been described in detail in the first embodiment, and the detailed explanation will not be repeated.

### (d2: Transfer Scheduling)

Next, the transfer scheduling in the host 10 will be described.

FIGS. 12A and 12B are schematic views each explaining the transfer scheduling in the USB communication system 1B according to the second embodiment. FIG. 12A shows an example of the transfer scheduling in the case where the number of connected stages for the function of the transfer destination is small, and FIG. 12B shows an example of the transfer scheduling in the case where the number of connected stages for the function of the transfer destination is large.

As shown in FIG. 12A, in the case where the number of connected stages for the function of the transfer destination is small, a delay that occurs in the data transfer between the host and the function is small. Thus, the intervals (response waiting periods) between the packets arranged in the frame are set shorter. In addition, the free period set at the end of the frame is also set shorter. More packets can be assigned to the frame by shortening such response waiting periods.

On the other hand, as shown in FIG. 12B, in the case where the number of connected stages for the function of the transfer destination is large, a delay that occurs in the data transfer between the host and the function is large. Thus, the intervals (response waiting periods) between the packets arranged in the frame is set longer. In addition, the free period set at the end of the frame is also set longer. The number of packets that can be assigned to the frame is reduced by setting the response waiting periods longer.

As shown in FIG. 12A and FIG. 12B, the transfer rate can be improved by adjusting the length of each response waiting period in accordance with the number of connected stages for the function of the transfer destination.

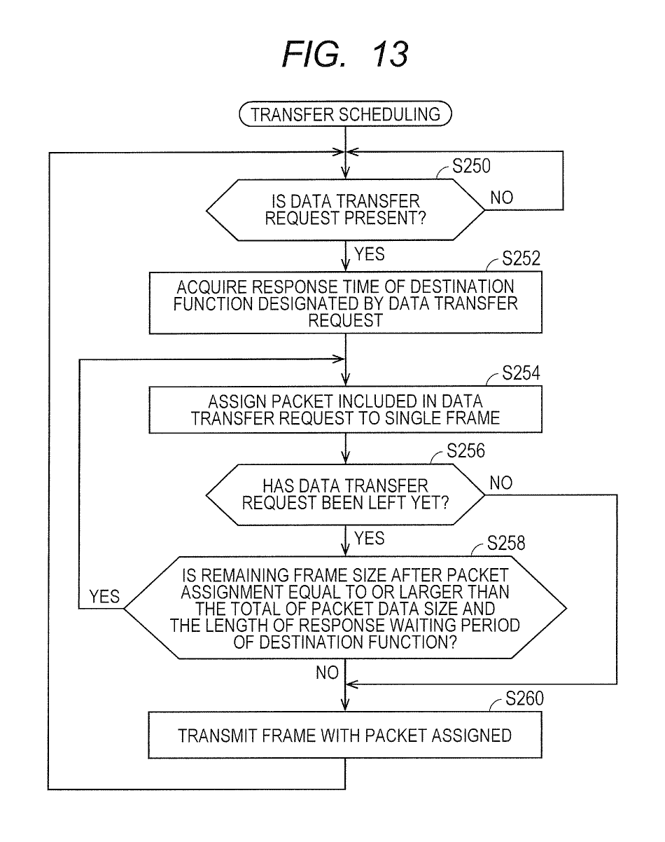

FIG. 13 is a flowchart for showing a processing procedure of the transfer scheduling in the USB communication system 1B according to the second embodiment. Each step shown in FIG. 13 is basically executed by the scheduler 122 (FIG. 10) of the host controller 120B.

With reference to FIG. 13, the host controller 120B determines whether or not a data transfer request (I/O request packet) from the client software 112 is present (Step S250). If no data transfer request is present (in the case of NO in Step S250), the process of Step S250 is repeated.

If the data transfer request is present (in the case of YES in Step S250), the host controller 120B acquires the response time of the function of the transfer destination designated by the data transfer request (Step S252). The response time of the function is calculated by the response time calculation module 144B (FIG. 10) on the basis of the number of connected stages for the function of the transfer destination stored in the connected stage number register 143. Next, the host controller 120B assigns packets included in the data transfer request to a single frame (Step S254). Then, after the assignment of the packets, the host controller 120B determines whether or not the data transfer request (I/O request packet) has been left yet (Step S256). If the data transfer request (I/O request packet) has been left yet (in the case of YES in Step S256), the host controller 120B determines whether or not the remaining frame size (remaining time) after the assignment of the packets is equal to or larger than the total of the packet data size (the length of the transmission period) and the length of the response waiting period of the function of the transfer destination (Step S258). If the remaining frame size after the assignment of the packets is equal to or larger than the total of the packet data size and the length of the response waiting period of the function of the transfer destination (in the case of YES in Step S258), the host controller 120B repeats the processes after Step S254.

If no data transfer request (I/O request packet) has been left (in the case of NO in Step S256) or if the remaining frame size after the assignment of the packets is smaller than the total of the packet data size and the length of the response waiting period of the function of the transfer destination (in the case of NO in Step S258), the frame with one or more packets assigned is transmitted (Step S260). Then, the processes after Step S250 are repeated.

As described above, the scheduler 122 of the host controller 120B adjusts the number or intervals of packets assigned to one frame on the basis of the driver information acquired by the driver information acquisition module 140.

### (d3: Advantage)

According to the host controller 120B of the first embodiment, the following advantage can be obtained in addition to that obtained by the host controller 120A according to the above-described first embodiment. Namely, the optimum response waiting time can be set for each function 30 connected to the port 130 of the host 10. Therefore, for example, in the case where there are many functions 30 each having the number of connected stages smaller than the maximum number of connected stages, the transfer rate can be more improved as compared to the first embodiment.

### E. Third Embodiment

In the above-described first and second embodiments, exemplified is a configuration in which the number of connected stages necessary for calculating the response time of the function is acquired by acquiring the driver information from the USB driver. On the contrary, in the third embodiment, exemplified is a configuration in which the number of connected stages is acquired during a process of activating a port when a device is connected and a process of setting an address. Namely, exemplified is a configuration in which the number of connected stages for the function is acquired using only the function of the host controller.

### (e1: System Configuration)

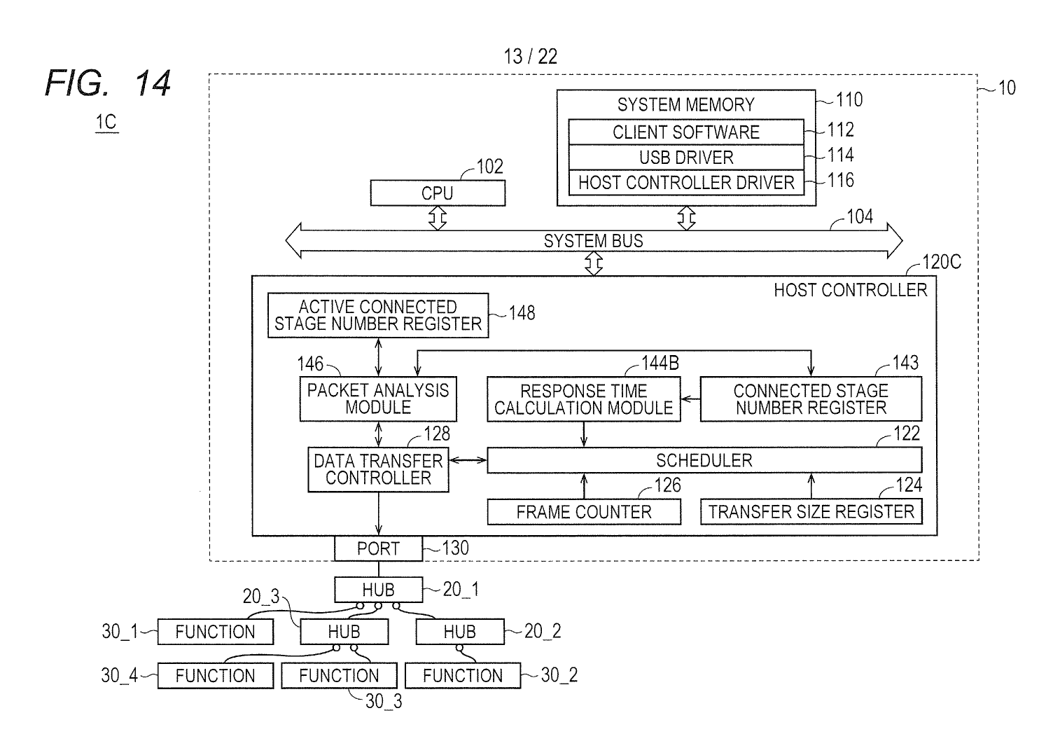

FIG. 14 is a schematic view for showing a system configuration of a USB communication system 1C according to a third embodiment. With reference to FIG. 14, the USB communication system 1C employs a host controller 120C instead of the host controller 120B as compared to the USB communication system 1B according to the second embodiment shown in FIG. 10. The host controller 120C employs a packet analysis module 146 and an active connected stage number register 148 instead of the driver information acquisition module 140 as compared to the host controller 120B shown in FIG. 10.

In the third embodiment, the packet analysis module 146 acquires information associated with the length of time from the time a packet is transmitted from the port 130 of the host 10 to the time a response from the function 30 that is a terminal of the transfer destination is received.

The packet analysis module 146 analyzes the content of a packet transmitted from or received by the port 130. In particular, the packet analysis module 146 detects a packet (a token packet, a data packet, a handshake packet, or the like) used for a process of assigning an address after some sort of device (the hub 20 or the function 30) is connected to the port 130, updates the number of connected stages of the hubs of an activated port stored in the active connected stage number register 148, and updates the number of connected stages for each of devices (the hub 20 and the function 30) stored in the connected stage number register 143.

The active connected stage number register 148 holds the number of hubs 20 existing on the route to the target device as work data for calculating the number of connected stages for each device connected to the port 130 (route hub).

As shown in FIG. 11, for example, the number of connected stages of each device is stored in the connected stage number register 143 on an address basis.

A process of acquiring the number of connected stages of the hubs will be described later. The other components have been described in detail in the first or second embodiment, and thus the detailed explanation will not be repeated.

### (e2: Acquisition of the Number of Connected Stages of Hubs)

Next, a process of acquiring the number of connected stages for the function connected to the host 10 will be described.

When a new node (the hub 20 or the function 30) is connected to the USB bus, the data transfer controller 128 of the host controller 120C carries out an initialization process in which an address is assigned to each node. More specifically, as a part of the initialization process, the data transfer controller 128 of the host controller 120C activates the port 130 serving as a route, activates the port of the hub 20, sets and acquires the address of the hub 20 whose port is activated, and sets and acquires the address of the function 30 connected to the hub 20. The packet analysis module 146 analyzes the transfer data transmitted on the USB bus. The packet analysis module 146 determines the number of connected stages of the hubs when a port was activated on the basis of the address of the hub 20 when the port was activated and the number of connected stages already stored in the active connected stage number register 148.

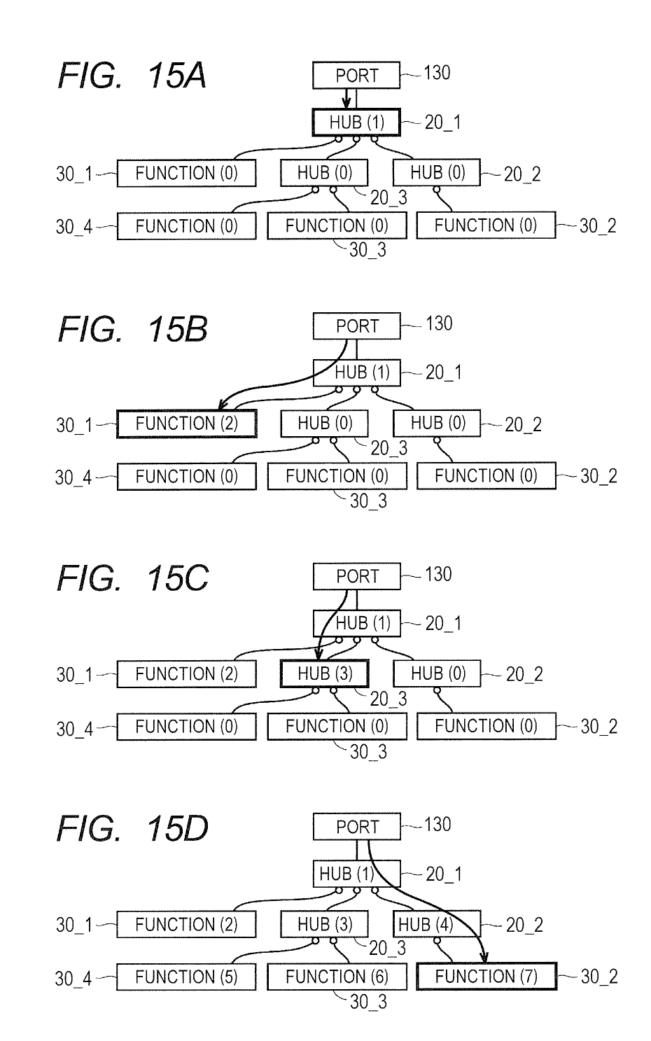

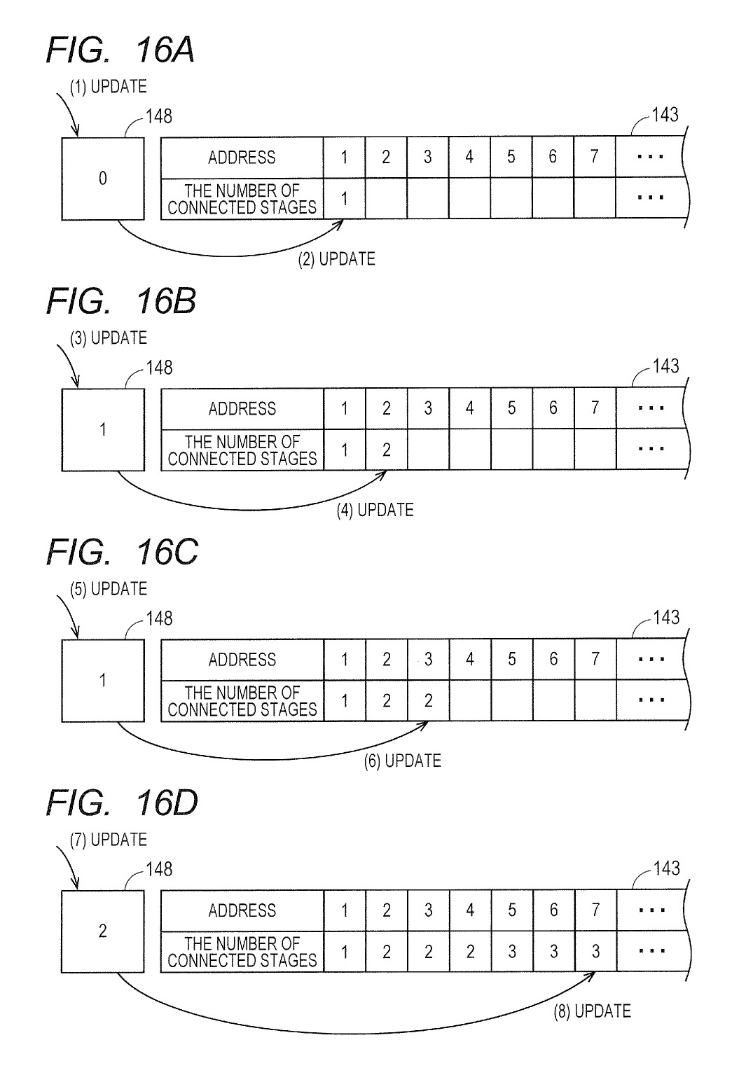

FIGS. 15A-15D are schematic views each showing a processing procedure of address setting in the USB communication system 10 according to the third embodiment. FIGS. 16A-16D are schematic views each explaining an updating process of the connected stage number register 143 and the active connected stage number register 148 while being associated with the address setting shown in FIGS. 15A-15D. The processes shown in FIGS. 15A-15D and FIGS. 16A-16D may be included in a part of the initialization process of the USB bus.

Each of FIGS. 15A to 15D shows a processing example in which addresses are sequentially set to a group of devices connected to the port 130. In each of FIGS. 15A to 15D, the numbers shown in parentheses following the device names represent assigned addresses. It should be noted that no addresses are set to any devices immediately after the connection, and each device stores “0” representing that no address is set.

As shown in FIG. 15A, the data transfer controller 128 of the host controller 120C first activates a downstream port of the port 130. Namely, the data transfer controller 128 activates the port 130, and starts to communicate with the hub 20_1 directly connected to the port 130. In this case, the packet analysis module 146 analyzes the content of a packet transmitted from the data transfer controller 128, determines that the number of hubs 20 provided on the route from the port 130 to the device (namely, the hub 20_1) of the transfer destination is 0, and “0” is set to the valid connected stage number register 148 ((1) update in FIG. 16A).

Next, the data transfer controller 128 assigns an address “1” to the hub 20_1. Namely, the data transfer controller 128 transmits to the hub 20_1 a command for changing the address from “0” to “1”. In accordance with the address setting, the packet analysis module 146 sets “the active number of connected stages+1” (namely, “1”) stored in the active connected stage number register 148 as the number of connected stages corresponding to the address “1” of the connected stage number register 143 ( (2) update in FIG. 16A).

Next, as shown in FIG. 15B, the data transfer controller 128 transmits to the hub 20_1 with the address “1” set a command for activating the first port thereof. Namely, the data transfer controller 128 activates the first port of the hub 20_1, and starts to communicate with the function 30_1 directly connected to the first port of the hub 20_1. In this case, the packet analysis module 146 analyzes the content of a packet transmitted from the data transfer controller 128, determines that the hub 20_1 is provided on the route from the port 130 to the device (namely, the function 30_1) of the transfer destination, and sets “1” to the active connected stage number register 148 ((3) update in FIG. 16B).

Next, the data transfer controller 128 assigns an address “2” to the function 30_1. Namely, the data transfer controller 128 transmits to the function 30_1 a command for changing the address from “0” to “2”. In accordance with the address setting, the packet analysis module 146 sets “the active number of connected stages+1” (namely, “2”) stored in the active connected stage number register 148 as the number of connected stages corresponding to the address “2” of the connected stage number register 143 ((4) update in FIG. 16B).

Next, as shown in FIG. 15C, the data transfer controller 128 transmits to the hub 20_1 with the address “1” set a command for activating the second port thereof. Namely, the data transfer controller 128 activates the second port of the hub 20_1, and starts to communicate with the hub 20_3 directly connected to the second port of the hub 20_1. In this case, the packet analysis module 146 analyzes the content of a packet transmitted from the data transfer controller 128, determines that the hub 20_1 is provided on the route from the port 130 to the device (namely, the hub 20_3) of the transfer destination, and sets “1” to the active connected stage number register 148 ((5) update in FIG. 16C).

Next, the data transfer controller 128 assigns an address “3” to the hub 20_3. Namely, the data transfer controller 128 transmits to the hub 20_3 a command for changing the address from “0” to “3”. In accordance with the address setting, the packet analysis module 146 sets “the active number of connected stages+1” (namely, “2”) stored in the active connected stage number register 148 as the number of connected stages corresponding to the address “3” of the connected stage number register 143 ((6) update in FIG. 16C).

An address is hereinafter set to each device by the similar procedure, and the values of the active connected stage number register 148 and the connected stage number register 143 are sequentially updated in accordance with the address setting. Namely, the data transfer controller 128 issues a command for activating the port of a specific hub 20 in the initialization process, and the packet analysis module 146 acquires the number of hubs existing on the route from the port 130 of the host 10 for the function 30 connected to the port of the hub 20 on the basis of the command for activating the port of the specific hub 20. It should be noted that the number of connected stages of each device is stored on an address basis as shown in FIGS. 16A-16D.

Finally, as shown in FIG. 15D, when the command for activating the first port is transmitted to the hub 20_2 with an address “4” set, the packet analysis module 146 analyzes the content of a packet transmitted from the data transfer controller 128, determines that the hub 20_1 and the hub 20_2 are provided on the route from the port 130 to the device (namely, the function 30_2) of the transfer destination, and sets “2” to the active connected stage number register 148 ((7) update in FIG. 16D). Then, when an address “7” is assigned to the function 30 2, the packet analysis module 146 sets “the active number of connected stages+1” (namely, “3”) stored in the active connected stage number register 148 as the number of connected stages corresponding to the address “7” of the connected stage number register 143 ((8) update in FIG. 16D).

The number of connected stages for each device is acquired by the above-described process. Namely, the packet analysis module 146 acquires the number of hubs 20 existing on the route from the port 130 of the host 10 to the function 30 that is the target terminal during the execution of the initialization process by the data transfer controller 128. Then, the response time is calculated for each function in accordance with the acquired number of connected stages.

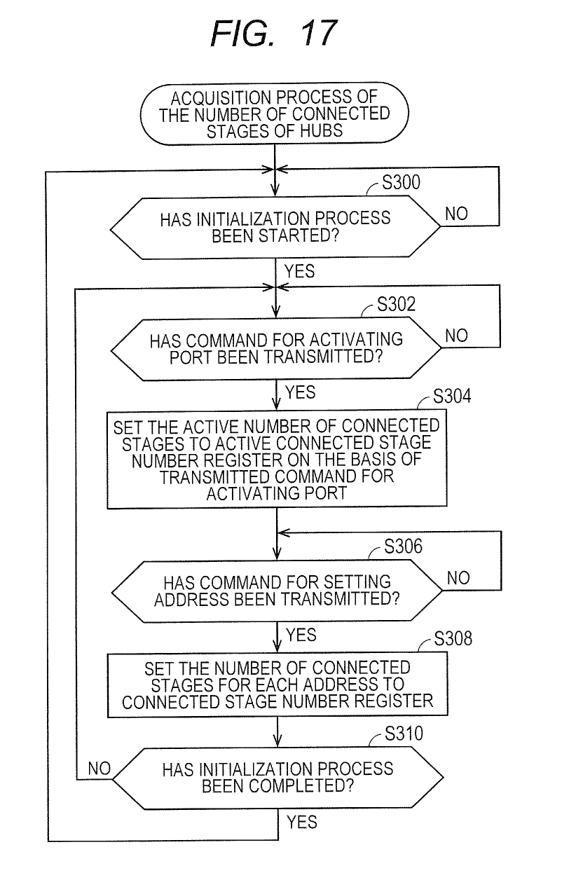

FIG. 17 is a flowchart for showing a processing procedure of acquiring the number of connected stages of the hubs in the USB communication system 1C according to the third embodiment. Each step shown in FIG. 17 is basically executed by the packet analysis module 146 (FIG. 14) of the host controller 120C.

With reference to FIG. 17, the packet analysis module 146 determines whether or not the initialization process has been started by the data transfer controller 128 (Step S300). If the initialization process has not been started (in the case of NO in Step S300), the process of Step S300 is repeated.

If the initialization process is started (in the case of YES in Step S300), the packet analysis module 146 determines whether or not a command for activating the port has been transmitted by the data transfer controller 128 (Step S302). If the command for activating the port has not been transmitted (in the case of NO in Step S302), the process of Step S302 is repeated.

If the command for activating the port is transmitted (in the case of YES in Step S302), the packet analysis module 146 sets the active number of connected stages to the active connected stage number register 148 on the basis of the transmitted command for activating the port (Step S304). Namely, the packet analysis module 146 updates the value of the active connected stage number register 148. Next, the packet analysis module 146 determines whether or not a command for setting an address has been transmitted by the data transfer controller 128 (Step S306). If the command for setting an address has not been transmitted (in the case of NO in Step S306), the process of Step S306 is repeated.

If the command for setting an address is transmitted (in the case of YES in Step S306), the packet analysis module 146 sets the number of connected stages for each device to the connected stage number register 143 using the value set in the active connected stage number register 148 and the address included in the command for setting an address (Step S308).

Next, the packet analysis module 146 determines whether or not the initialization process has been completed by the data transfer controller 128 (Step S310). If the initialization process has not been completed (in the case of NO in Step S310), the processes after Step S302 are repeated. On the contrary, if the initialization process has been completed (in the case of YES in Step S310), the process is returned to Step S300.

The number of connected stages for each device (address) of the transfer destination is acquired as shown in FIGS. 16A-16D by the above-described processing procedure.

### (e3: Transfer Scheduling)

Next, the processing procedure of the transfer scheduling in the host 10 is basically the same as that in the USB communication system 1B according to the above-described second embodiment. Namely, the transfer scheduling is carried out in accordance with the flowchart shown in FIG. 13. Thus, the detailed explanation will not be repeated.

### (e4: Advantage)

The host controller 120C according to the third embodiment can easily acquire the number of connected stages of the hubs for each function in the initialization process that is started after the device (the hub 20 or the function 30) is connected to the port 130 of the host 10. The response waiting time after transmission of a packet can be optimized by acquiring such information in accordance with the delay time of the data transfer that may occur in the actual connection configuration. Namely, the response waiting time is not uniformly set in accordance with the maximum number of connected stages in the standard as described in the related technique, but the response waiting time can be shortened in accordance with the actual connection configuration (namely, the maximum value of connected stages). Accordingly, the number of packets assigned to a frame can be increased, and as a result, the transfer rate can be improved.

Further, the configuration of the third embodiment can be realized by adding a function of analyzing a command issued during the initialization process to the configuration of the above-described related technique. Namely, the host controller 120C according to the third embodiment can be realized only by making a relatively-simple improvement to the host controller compliant with the related technique.

### F. Fourth Embodiment

In the above-described third embodiment, exemplified is a configuration in which the response time of each function is calculated in accordance with the number of connected stages. However, the response time may be uniformly determined using the maximum one (the maximum number of connected stages) among those acquired for the respective devices.

In a USB communication system according to a fourth embodiment, the number of connected stages for each device is acquired in accordance with the processing procedure similar to the above-described third embodiment.

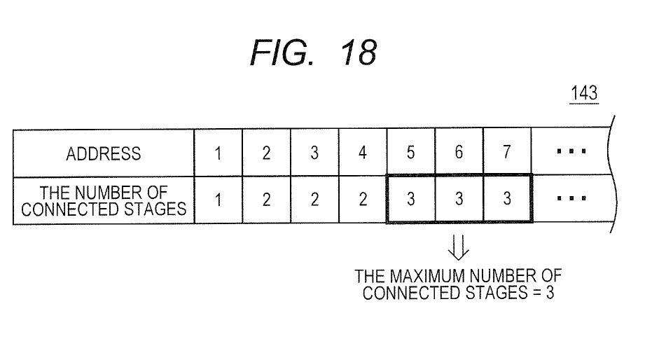

FIG. 18 is a schematic view for explaining a process of acquiring the maximum number of connected stages of the hubs in the USB communication system according to the fourth embodiment. With reference to FIG. 18, for example, among the numbers of connected stages for the devices (the hub 20 and the function 30) stored in the connected stage number register 143, the maximum number is determined as the maximum number of connected stages. Namely, the maximum value (the maximum number of connected stages) of the hubs existing on the routes from the port 130 of the host 10 to the respective functions 30 connected to the port 130 of the host 10 is acquired. Then, the host controller carries out the transfer scheduling on the basis of the response time in accordance with the acquired maximum number of connected stages.

The processing procedure of the transfer scheduling in the USB communication system according to the fourth embodiment is basically the same as that in the USB communication system 1A according to the above-described first embodiment. Namely, the transfer scheduling is carried out in accordance with the flowchart shown in FIG. 9. Therefore, the detailed explanation will not be repeated.

According to the host controller of the fourth embodiment, the following advantage can be obtained in addition to that obtained by the host controller 120C according to the above-described third embodiment. Namely, it is not necessary to manage the response waiting time for each function 30, and thus a processing logic can be simplified as compared to the third embodiment.

### G. Fifth Embodiment

In the above-described first to fourth embodiments, exemplified is a configuration in which the response time is statically determined on the basis of the connection relation of each device. On the contrary, in the fifth embodiment, exemplified is a configuration in which the response time is dynamically determined on the basis of a period of time required for actual data transfer.

### (g1: System Configuration)

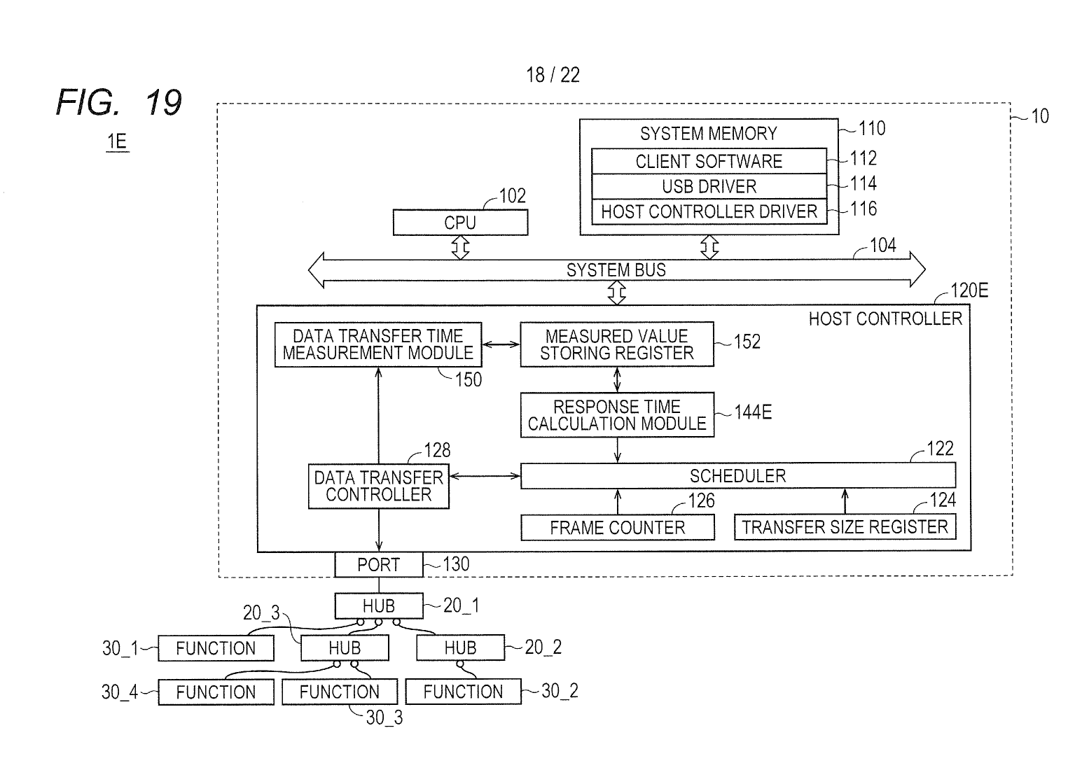

FIG. 19 is a schematic view for showing a system configuration of a USB communication system 1E according to the fifth embodiment. With reference to FIG. 19, the USB communication system 1E employs a host controller 120E instead of the host controller 120A as compared to the USB communication system 1A according to the first embodiment shown in FIG. 5. The host controller 120E employs a data transfer time measurement module 150 and a measured value storing register 152 instead of the driver information acquisition module 140 as compared to the host controller 120A shown in FIG. 5. Further, a response time calculation module 144E is employed instead of the response time calculation module 144A.

The data transfer time measurement module 150 measures a period of time required from the time a packet is transmitted from the port of the host 10 followed by reception by the function 30 that is a terminal of the transfer destination to the time a response transmitted in accordance with the packet received by the terminal is received by the port of the host 10. More specifically, the data transfer time measurement module 150 analyzes the content of a packet transmitted from or received by the port 130 to measure a period of time required for the data transfer. Namely, the data transfer time measurement module 150 analyzes the transfer data on the USB bus to measure the response time of the received data from the function 30 relative to the transmitted data transmitted from the host 10.

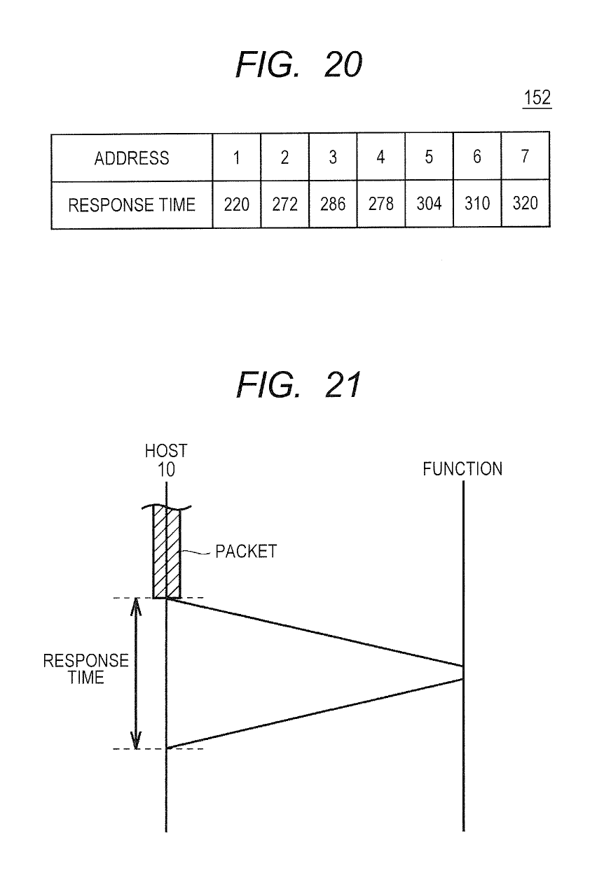

The measured value storing register 152 stores therein the response time measured by the data transfer time measurement module 150. Basically, the response time measured for each device (address) of the transfer destination is stored into the measured value storing register 152. FIG. 20 is a diagram for showing an example of data stored in the measured value storing register 152 of the USB communication system lE according to the fifth embodiment. With reference to FIG. 20, for example, the response time of each device is stored on an address basis. Namely, the response time is measured for each function 30 connected to the port 130 of the host 10. As a unit of the response time, for example, a bit time (a period occupying a line to transmit and receive one bit) or the like is used.

A plurality of measurement results (response times) may be stored for one device (address), or, as will be described later, only the shortest measurement result (response time) may be stored for one device (address). In the latter case, the data transfer time measurement module 150 measures the response time for any one of the devices. In the case where the measured response time is shorter than the response time stored in the measured value storing register 152, the value of the measured value storing register 152 may be updated using the measured response time. Namely, the data transfer time measurement module 150 may hold the minimum time as a measurement result among a plurality of response times measured for the same transfer destination.

Then, the scheduler 122 of the host controller 120E performs scheduling so as to wait for a response to a packet transmitted to the transfer destination over a period corresponding to the time measured by the data transfer time measurement module 150 from the transmission of the packet. More specifically, the response time calculation module 144E measures a period of time (response time) required from the time a packet is transmitted to each transfer destination to the time a response from the function of the transfer destination is transferred to the host 10 on the basis of the measurement result stored in the measured value storing register 152. The length of the response waiting period is determined in accordance with the response time for each address of the transfer destination, and the transfer scheduling is carried out in accordance with the length of the determined response waiting period.

The response time calculation module 144E may determine the measurement result stored in the measured value storing register 152 as the response waiting period as it is, or may adjust the length of the response waiting period in accordance with the data size of the packet. A method of determining the response waiting period will be described later.

The other functions and processes have been described in detail in the first to fourth embodiments, and thus the detailed explanation will not be repeated.

### (g2: Time Measurement of Data Transfer and Acquisition of Response Time)

Next, measurement of time required for data transfer and a method of acquiring the response time will be described. The data transfer time measurement module 150 analyzes transfer data transmitted on the USB bus to measure the length of a period from the time the transmission of transmission data from the port 130 is completed to the time a response to the transmission data is received from the function of the transfer destination.

FIG. 21 is a schematic view for explaining measurement of time required for the data transfer in the USB communication system 1E according to the fifth embodiment. With reference to FIG. 21, the data transfer time measurement module 150 measures, as the response time, a period from the time the transmission of a packet from the host 10 (port 130) is completed to the time a response to the packet is received from the function 30 of the transfer destination. The measurement of the response time is carried out for each device (address) of the transfer destination. The measurement of the response time may be carried out during the initialization process, or may be carried out at the time of normal data transfer.

The response time to be measured can be classified into time (the response delay in the function) that is possibly changed depending on a packet and time (the cable delay and the hub delay) that is constant irrespective of a packet. Therefore, a value obtained by adding the time that is possibly changed depending on a packet to the minimum value of the measured response time may be set as the length of the response waiting period of the function. Namely, in the USB communication system 1E according to the fifth embodiment, the minimum value of the response time is measured for each device (address) of the transfer destination, and time obtained by adding a predetermined margin to the minimum value of each measured response time is set as the length of the response waiting period of the function. As described above, the period (response waiting period) of waiting for a response to a packet transmitted to the transfer destination is calculated by adding a predetermined period to the measurement result by the data transfer time measurement module 150.

It should be noted that, as another configuration, the maximum value (namely, the worst value) of the measured response time may be set as the length of the response waiting period of the function.

As still another configuration, the response time to be measured may be statistically classified into time that is possibly changed depending on a packet and time that is constant irrespective of a packet on the basis of the type or data size of a packet to be measured. As described above, the length of the response waiting period can be dynamically set in accordance with a packet to be transmitted by separately acquiring two components.

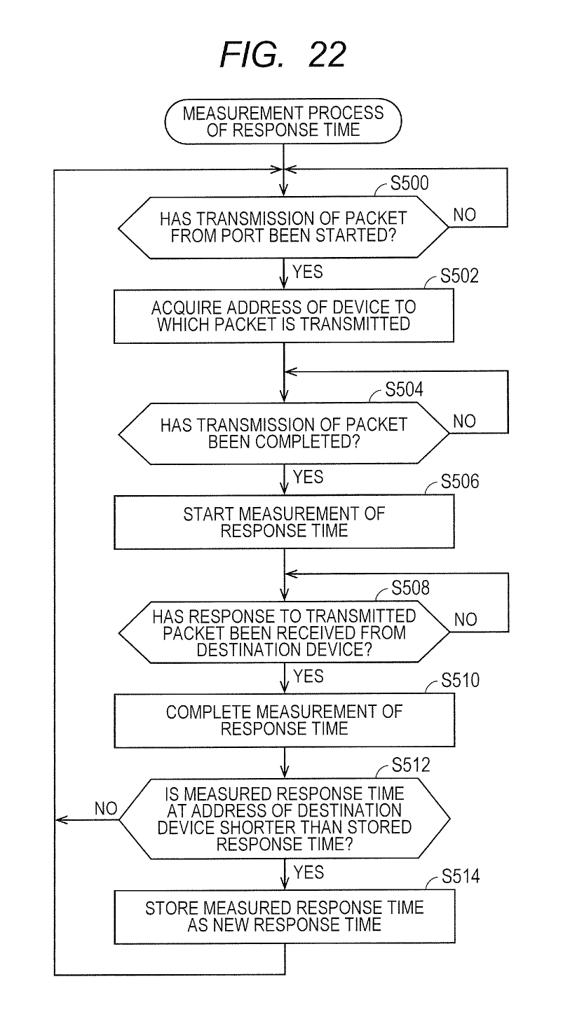

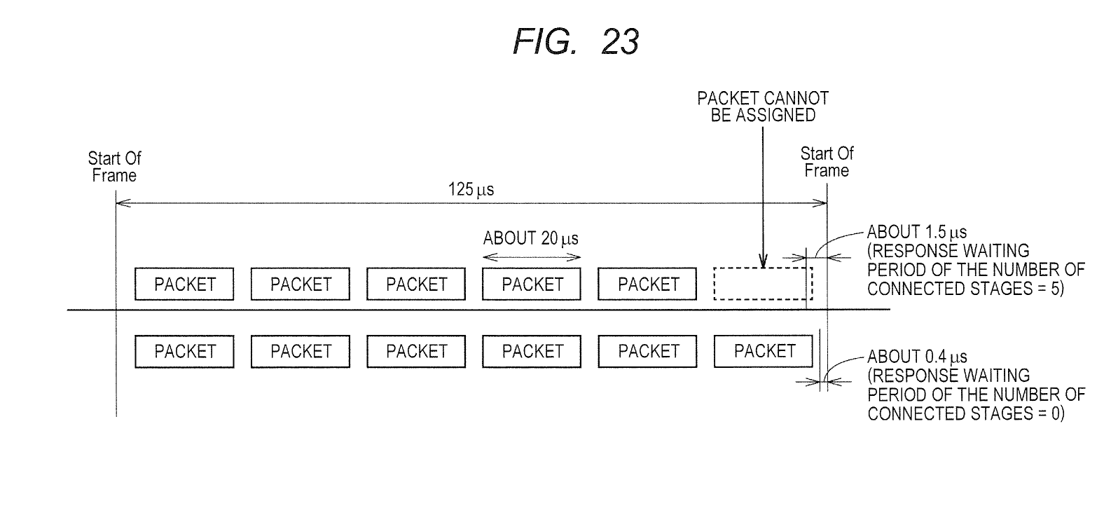

FIG. 22 is a flowchart for showing a measurement procedure of the response time in the USB communication system 1E according to the fifth embodiment. Each step shown in FIG. 22 is basically executed by the data transfer time measurement module 150 (FIG. 19) of the host controller 120E.

With reference to FIG. 22, the host controller 120E determines whether or not the transmission of a packet from the port 130 has been started (Step S500). If the transmission of a packet from the port 130 has not been started (in the case of NO in Step S500), the process of Step S500 is repeated.

On the contrary, if the transmission of a packet from the port 130 is started (in the case of YES in Step S500), the host controller 120E acquires the address of the device to which the packet has been transmitted (Step S502). Next, the host controller 120E determines whether or not the transmission of the packet has been completed (Step S504). If the transmission of the packet has not been completed (in the case of NO in Step S504), the process of Step S504 is repeated.

On the contrary, if the transmission of the packet is completed (in the case of YES in Step S504), the host controller 120E activates a timer to start the measurement of the response time (Step S506). Then, the host controller 120E determines whether or not a response to the packet transmitted earlier has been received from the device of the transfer destination (Step S508). If a response to the packet transmitted earlier has not been received from the device of the transfer destination (in the case of NO in Step S508), the process of Step S508 is repeated.

If a response to the packet transmitted earlier is received from the device of the transfer destination (in the case of YES in Step S508), the host controller 120E stops the timer to complete the measurement of the response time (Step S510).

The host controller 120E determines whether or not the measured response time at the address of the destination device is shorter than that stored in the measured value storing register 152 (Step S512). If the measured response time is shorter than that acquired earlier (in the case of YES in Step S512), the host controller 120E stores the measured response time into the measured value storing register 152 as a new response time (Step S514). Then, the process is returned to Step S500.

On the contrary, if the measured response time is equal to or longer than that acquired earlier (in the case of NO in Step S512), the updating process of Step S514 is not carried out, and the process is returned to Step S500.

As described above, the host controller 120E acquires the address of the transfer destination when starting the transmission of data from the host, and starts the measurement when the transmission of data is completed. Then, the host controller 120E completes the measurement when starting to receive response data in the host, and compares the measured value with the stored transmission/reception interval for each address of the function of the data transfer destination. If shorter, the value is updated.

### (g3: Transfer Scheduling)

Next, the processing procedure of the transfer scheduling in the host 10 is basically the same as that in the USB communication system 1B according to the above-described second embodiment. Namely, the transfer scheduling is carried out in accordance with the flowchart shown in FIG. 13. Therefore, the detailed explanation will not be repeated.

### (g4: Advantage)

The host controller 120E according to the fifth embodiment can measure the response time of each function 30 by monitoring exchanges (transactions) of data between the host 10 and the device (the hub 20 or the function 30). In addition, the response waiting time after transmission of a packet can be optimized on the basis of the response time measured for each function 30. Namely, the response waiting time is not uniformly set in accordance with the maximum number of connected stages in the standard as described in the related technique, but the response waiting time can be shortened in accordance with the actual connection configuration (namely, the maximum value of connected stages). Accordingly, the number of packets assigned to a frame can be increased, and as a result, the transfer rate can be improved.

Further, the configuration of the fifth embodiment can be realized by adding a function of monitoring exchanges (transactions) of data between the host 10 and the device (the hub 20 or the function 30) to the configuration of the above-described related technique. Namely, the host controller 120E according to the fifth embodiment can be realized only by making a relatively-simple improvement to the host controller compliant with the related technique.

### H. Sixth Embodiment

In the above-described fifth embodiment, exemplified is a configuration in which the response time is calculated for each function in accordance with the number of connected stages. However, the response time may be uniformly determined using the maximum value (the maximum number of connected stages) among the acquired numbers of connected stages for the respective devices.

In a USB communication system according to a sixth embodiment, the response time is measured for each device (address) in accordance with the processing procedure similar to the above-described fifth embodiment. In addition, the maximum time among the response times of the devices (the hub 20 and the function 30) is determined as the maximum response time. Namely, the maximum time among the response times measured for the functions 30 connected to the port 130 of the host 10 is acquired as the response time (representative value) in a target connection configuration. The host controller determines the length of the response waiting period in accordance with the determined maximum response time, and carries out the transfer scheduling.

The processing procedure of the transfer scheduling in the USB communication system according to the sixth embodiment is basically the same as that in the USB communication system 1A according to the above-described first embodiment. Namely, the transfer scheduling is carried out in accordance with the flowchart shown in FIG. 9. Therefore, the detailed explanation will not be repeated.

According to the host controller of the sixth embodiment, the following advantage can be obtained in addition to that obtained by the host controller 120E according to the above-described fifth embodiment. Namely, it is not necessary to manage the response waiting time for each function 30, and thus a processing logic can be simplified as compared to the fifth embodiment.

### I. Effect of Improvement of Transfer Rate

Next, an effect of an improvement in the transfer rate by the transfer scheduling according to the embodiments will be described.

FIG. 23 is a schematic view for showing an example of an effect of an improvement in the transfer rate by the transfer scheduling according to the embodiments. FIG. 23 shows an example of the response waiting period set in the case where the numbers of connected stages are “5” and “0”.

In the response waiting period set in the case where the number of connected stages is “5”, only five packets are assigned to one frame. On the other hand, in the response waiting period set in the case where the number of connected stages is “0”, six packets can be assigned to one frame. Namely, in the above-described related technique, the response waiting period is set and the transfer scheduling is carried out on the assumption that the number of connected stages is “5” in any case. On the contrary, in the transfer scheduling according to the embodiments, the response waiting period is set in accordance with an actual connection configuration, and thus more packets can be assigned.

For example, if the data size of one packet is 1024 bytes and the cycle of one frame is 125 μs, the transfer rate is calculated as follows.

### <Related Technique>

Five packets (1024 bytes per packet) are transferred per one frame (125 μs).

8000 frames/s×1024 bytes×5 times×8 bits=327.6 Mbps

### Embodiments

Six packets (1024 bytes per packet) are transferred per one frame (125 μs).

8000 frames/s×1024 bytes×6 times×8 bits=393.2 Mbps

As an effect of an improvement in the transfer rate, 393.216/327.6=120 (%) is satisfied, and the transfer rate can be improved by 20%.

### J. Mounting Mode

The host 10 according to the embodiments is typically mounted as a personal computer, a general-purpose microcomputer, or a dedicated device for specific use. The host controller may be mounted as a substrate or a chip connected a bus of a personal computer. Alternatively, the host controller and a cache memory in addition to a processor may be mounted on the same substrate (for example, SoC (System-on-a-Chip)).

The host controller according to the embodiments may be mounted as an integrated circuit such as an LSI (Large-Scale Integration) or pure hardware such as a hard wired logic.

Alternatively, the host controller may be configured using a combination of hardware and software, for example, using a communication circuit and a microcontroller for controlling the communication circuit, and a program (for example, firmware) for allowing the microcontroller to execute a necessary process may be stored in an EEPROM (Electrically Erasable Programmable Read-Only Memory) or a flash memory.

Furthermore, all the processes necessary for the host controller may be implemented by software using a device that can process a signal at a high speed such as a DSP (Digital Signal Processor).

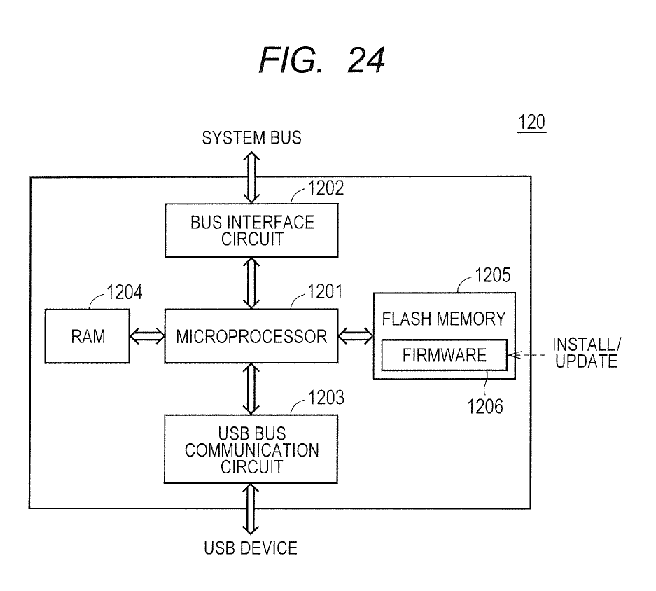

FIG. 24 is a schematic view for showing a configuration example of a host controller 120 according to the embodiments. FIG. 24 shows a configuration example in which the host controller 120 is mounted using a combination of a communication circuit and a microprocessor. More specifically, the host controller 120 includes a microprocessor 1201, a bus interface circuit 1202, a USB bus communication circuit 1203, a RAM (Random Access Memory) 1204, and a flash memory 1205.

The bus interface circuit 1202 exchanges signals with the CPU and the system memory (see FIG. 5) through a system bus. The USB bus communication circuit 1203 manages transfer scheduling and data transfer. Namely, the USB bus communication circuit 1203 provides functions corresponding to the scheduler 122 and the data transfer controller 128 (see FIG. 5 and the like).

The microprocessor 1201 controls the bus interface circuit 1202 and the USB bus communication circuit 1203, so that exchanges of data between the both circuits are mediated. More specifically, the microprocessor 1201 reads and executes firmware 1206 stored in the flash memory 1205 to realize a necessary process. The RAM 1204 functions as a work memory that temporarily stores data necessary for the microprocessor 1201 to execute the firmware 1206.

The firmware 1206 is a kind of auxiliary program, and can be installed or updated from the outside. The flash memory 1205 stores various kinds of data including the firmware 1206 in a non-volatile manner. The RAM 1204 is typically mounted using a DRAM (Dynamic Random Access Memory), an SRAM (Static Random Access Memory), or the like.

For example, the firmware 1206 may be distributed in a state of being stored in a non-transitory recording medium, and may be installed into the flash memory 1205 or updated. As the non-transitory recording medium, an optical recording medium such as an optical disk, a semiconductor recording medium such as a flash memory, a magnetic recording medium such as a hard disk or a storage tape, or a magneto-optical recording medium such as an MO (Magneto-Optical disk) may be used. Namely, the embodiments may include a computer-readable program and a recording medium storing the program for realizing the above-described processes and functions.

As a different mode, the firmware 1206 may be downloaded from a server device through the Internet or an intranet.

The host controller according to the embodiments and the host including the host controller can be realized by those skilled in the art by appropriately using a technique in response to the times when the present invention is carried out.

### K. Summary

As described with reference to the above-described first to sixth embodiments, the response waiting time is optimized in accordance with an actual connection configuration, and the transfer scheduling is carried out in accordance with the optimized response waiting time, so that the transfer rate can be improved under the restriction in which unit frames are repeatedly transmitted and received at predetermined cycles.

The invention achieved by the inventors has been described above in detail on the basis of the embodiments. However, it is obvious that the present invention is not limited to the above-described embodiments, and can be variously changed without departing from the scope of the invention.

1. A host controller having a function of communicating with one or more nodes through a bus connected to a host port, the one or more nodes including, at least, one of a terminal located at an end of the bus and a hub that connects a port on the upper-level side to one or more ports in a cascade manner,
the host controller comprising:
scheduling means that assigns one or more packets to each frame having a predetermined cycle;
communication means that performs bidirectional communications by switching the data transfer direction of the bus in time in accordance with the assignment by the scheduling means; and
acquisition means that acquires information associated with the length of time required from the time a packet is transmitted from the host port followed by reception by a terminal of a transfer destination to the time a response transmitted in accordance with the packet received by the terminal is received by the host port,
wherein the scheduling means adjusts the number or intervals of packets assigned to one frame on the basis of the information acquired by the acquisition means.

2. The host controller according to claim 1,
wherein the host controller is connected to a main operation unit that executes application software using communications with the one or more nodes and driver software controlling the host controller, and
wherein the acquisition means acquires the information by referring to driver information held by the driver software.

3. The host controller according to claim 2,
wherein the acquisition means acquires, as the information, the number of hubs existing on the route from the host port to each terminal on the basis of the driver information.

4. The host controller according to claim 3,
wherein the acquisition means acquires, as the information, the maximum value of the numbers of hubs existing on the routes from the host port to the respective terminals connected to the host port.

5. The host controller according to claim 3,
wherein the acquisition means acquires the number of hubs existing on the route from the host port to each terminal connected to the host port.

6. The host controller according to claim 2,
wherein when a new node is connected to the bus, the communication means carries out an initialization process in which an address is assigned to the node, and
wherein the acquisition means acquires, as the information, the number of hubs existing on the route from the host port to a target terminal during the execution of the initialization process by the communication means.

7. The host controller according to claim 6,
wherein the communication means issues a command for activating a port of a specific hub in the initialization process, and
wherein the acquisition means acquires the number of hubs existing on the route from the host port to a terminal connected to the port of the hub on the basis of the command for activating the port of the specific hub.

8. The host controller according to claim 6,
wherein the acquisition means acquires the number of hubs existing on the route from the host port to each terminal connected to the host port.

9. The host controller according to claim 6,
wherein the acquisition means acquires, as the information, the maximum value of the numbers of hubs existing on the routes from the host port to the respective terminals connected to the host port.

10. The host controller according to claim 1,
wherein the acquisition means measures a period of time required from the time a packet is transmitted from the host port followed by reception by a terminal of a transfer destination to the time a response transmitted in accordance with the packet received by the terminal is received by the host port, and
wherein the scheduling means carries out scheduling so as to wait for the response to the packet over a period corresponding to the period of time measured by the acquisition means from the transmission of the packet to the transfer destination.

11. The host controller according to claim 10,
wherein the acquisition means holds the minimum value as a measurement result among a plurality of periods of time measured for the same transfer destination, and
wherein the period of waiting for the packet from the transmission of the packet to the transfer destination is calculated by adding a predetermined period to the measurement result by the acquisition means.

12. The host controller according to claim 10,
wherein the acquisition means measures the period of time for each terminal connected to the host port.

13. The host controller according to claim 10,
wherein the acquisition means acquires, as the information, the maximum value of the periods of time measured for the respective terminals connected to the host port.

14. A program executed by a host controller having a function of communicating with one or more nodes through a bus connected to a host port, the one or more nodes including, at least, one of a terminal located at an end of the bus and a hub that connects a port on the upper-level side to one or more ports in a cascade manner, the program allowing the host controller to execute the steps of:
assigning one or more packets to each frame having a predetermined cycle;
acquiring information associated with the length of time required from the time a packet is transmitted from the host port followed by reception by a terminal of a transfer destination to the time a response transmitted in accordance with the packet received by the terminal is received by the host port; and
adjusting the number or intervals of packets assigned to one frame on the basis of the acquired information,
wherein the host controller performs bidirectional communications by switching the data transfer direction of the bus in time in accordance with the assignment of the one or more packets.

15. The host controller according to claim 7,
wherein the acquisition means acquires the number of hubs existing on the route from the host port to each terminal connected to the host port.

16. The host controller according to claim 7,
wherein the acquisition means acquires, as the information, the maximum value of the numbers of hubs existing on the routes from the host port to the respective terminals connected to the host port.

17. The host controller according to claim 11,
wherein the acquisition means measures the period of time for each terminal connected to the host port.

18. The host controller according to claim 11,
wherein the acquisition means acquires, as the information, the maximum value of the periods of time measured for the respective terminals connected to the host port.
